(19) United States
(12) Patent Application Publication
(10) Pub. No.: US 2026/0222371 A1
(43) Pub. Date: Jul. 30, 2026

(54) INFORMATION PROCESSING SYSTEM, INFORMATION PROCESSING APPARATUS, AND INFORMATION PROCESSING METHOD

(71) Applicant: Genki WATANABE, Tokyo (JP)

(72) Inventor: Genki WATANABE, Tokyo (JP)

(21) Appl. No.: 19/443,049

(22) Filed: Jan. 8, 2026

(30) Foreign Application Priority Data
Jan. 24, 2025 (JP) 2025-010681
Oct. 6, 2025 (JP) 2025-168469

(51) Int. Cl. H04L 51/02; G06F 3/04817; G06F 3/0482; G06F 3/0484

(52) U.S. Cl. CPC H04L 51/02; G06F 3/04817; G06F 3/0482; G06F 3/0484

(57) ABSTRACT

An information processing system includes circuitry. The circuitry receives an input message for an interactive AI interacting with a user, searches for document data using the input message, transmits the searched document data to an external system, acquires an execution result of an external function executed using the transmitted document data from the external system, and displays the acquired execution result on a display.

### CROSS-REFERENCE TO RELATED APPLICATIONS

This patent application is based on and claims priority pursuant to 35 U.S.C. § 119(a) to Japanese Patent Application Nos. 2025-010681, filed on Jan. 24, 2025, and 2025-168469, filed on Oct. 6, 2025, in the Japan Patent Office, the entire disclosure of each of which is hereby incorporated by reference herein.

### BACKGROUND

### Technical Field

The present disclosure relates to an information processing system, an information processing apparatus, and an information processing method.

### Related Art

Techniques have been developed to generate documents and search for information by interaction with interactive artificial intelligence (AI).

Further, techniques have been developed to utilize an external function provided by an external server device for data processing necessary for a business.

### SUMMARY

The present disclosure described herein provides an information processing system including circuitry. The circuitry receives an input message for an interactive AI interacting with a user, searches for document data using the input message, transmits the searched document data to an external system, acquires an execution result of an external function executed using the transmitted document data from the external system, and displays the acquired execution result on a display.

The present disclosure described herein provides an information processing apparatus including circuitry. The circuitry receives an input message for an interactive AI interacting with a user, searches for document data using the input message, transmits the searched document data to an external system, acquires an execution result of an external function executed using the transmitted document data from the external system, and displays the acquired execution result on a display.

The present disclosure described herein provides an information processing method including receiving, searching, transmitting, acquiring, and displaying. The receiving includes receiving an input message for an interactive AI interacting with a user. The searching includes searching for document data using the input message. The transmitting includes transmitting the searched document data to an external system. The acquiring includes acquiring an execution result of an external function executed using the transmitted document data from the external system. The displaying includes displaying the acquired execution result on a display.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing system;

FIG. 2 is a diagram illustrating a hardware configuration of an information processing apparatus or a terminal apparatus;

FIG. 3 is a diagram illustrating a functional configuration of an information processing system;

FIG. 4 is a diagram illustrating an example of chunk information stored in a data storage unit;

FIG. 5 is a diagram illustrating agent information stored in an agent information storage unit;

FIG. 6 is a diagram illustrating an example of user information stored in a user information storage unit;

FIG. 7 is a diagram illustrating an example of workflow information stored in a workflow information storage unit;

FIG. 8 is a diagram illustrating an example of history information stored in a history information storage unit;

FIG. 9 is a diagram illustrating processes performed by a workflow tool;

FIG. 10 is a simplified diagram illustrating a workflow definition performed by a workflow tool;

FIG. 11 is a diagram illustrating a registration screen for registering a workflow in an agent;

FIG. 12 is a sequence diagram illustrating operations and processes executed by an information processing system;

FIG. 13 is a sequence diagram illustrating operations and processes executed by an information processing system in relation to responding to an input message;

FIG. 14 is a sequence diagram illustrating operations and processes executed by an information processing system in relation to workflow proposal;

FIG. 15 is a sequence diagram illustrating operations and processes executed by an information processing system in relation to workflow execution;

FIG. 16 is a flowchart of a determination method when (1) priority is given to a chart history;

FIG. 17 is a flowchart of a determination method when (2) priority is given to association with search-adapted document data;

FIG. 18 is a flowchart of a determination method when (3) priority is given to association with an executing agent;

FIG. 19 is a flowchart of a determination method when (4) priority is given to association with a department to which a user belongs;

FIG. 20 is a diagram illustrating an interactive screen displayed at the start of interaction;

FIG. 21 is a diagram illustrating an interactive screen including output information;

FIG. 22 is a diagram illustrating an interactive screen displayed when document data is selected;

FIG. 23 is a diagram illustrating an interactive screen including a workflow list;

FIG. 24 is a diagram illustrating an interactive screen including response information;

FIG. 25 is a diagram illustrating an interactive screen including an input message resulting from the selection of an option;

FIG. 26 is another diagram illustrating an interactive screen including response information;

FIG. 27 is a diagram illustrating a functional configuration of a terminal apparatus according to a second embodiment; and

FIG. 28 is a sequence diagram illustrating a procedure for displaying a response message and other information according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

An information processing system and an information processing method performed by the information processing system are described below with reference to the drawings.

### First Embodiment

### System Configuration

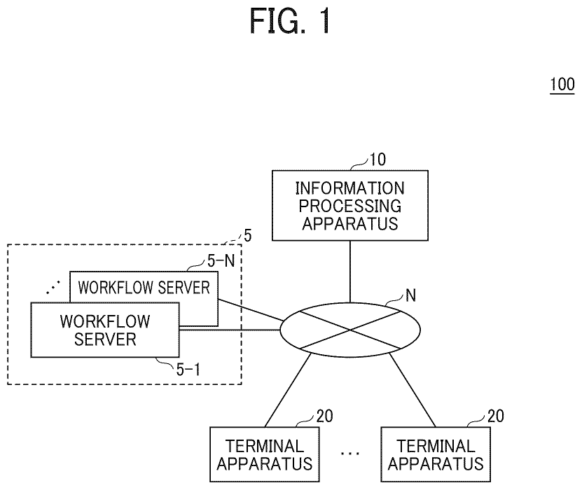

FIG. 1 is a diagram illustrating a configuration of an information processing system 100. In FIG. 1, one or more terminal apparatuses 20 are connected to an information processing apparatus 10 via a network N such as a local area network (LAN) or the Internet.

The information processing apparatus 10 is implemented by one or more computers provided with software that interacts with a user. This software may be referred to as “agent” in the following description. The agent is an example of interactive artificial intelligence (AI), and is an anthropomorphic virtual entity that appears to the user as a dialogue partner. In the interaction with the interactive AI as a dialogue partner, the interactive AI outputs a response to a message input by the user. In the present embodiment, the agent also displays a list of document data adapted to the search of the input message. Specifically, the agent receives an input message, which is a message input by the user, from the terminal apparatus 20, searches for document data, and generates a response message based on the document data. The agent outputs output information including the response message and the list of document data to the terminal apparatus 20. The input message may be a question, an instruction, a request, or any other input information that requires a response message. The response message is text that includes information corresponding to the input message. Alternatively, the response message may be output by voice.

The agent generates the response message using Retrieval-Augmented Generation (RAG). The RAG refers to a technique in which a large language model (LLM) generates responses based on information extracted by searching a company's memory unit, which stores a large volume of business documents, regulations, internal company information, and external information. The RAG enables generation of a factual response message with reference to a database that retains accurate information.

However, simply acquiring the document data by, for example, RAG allows the information processing system 100 to support only a part of the user's work. For example, demand exists for automating the generation of documents in a predetermined format using document data, detailed analysis, and future forecasting. In addition, support is required for downstream operations following information generation, such as scheduling reviews of generated response messages and reserving meeting rooms.

Further, high accuracy is required for a display format of the generated document data. It may be required to output the image data in an individual display format customized for each user. In these cases, the agent needs to perform output in accordance with a required display format.

To meet the needs, the information processing system 100 supports the user's work in cooperation with one or more external workflow servers 5-1 to 5-N based on the document data or the response message acquired by, for example, RAG. A workflow for supporting the user's work is set in advance in each of the one or more workflow servers 5-1 to 5-N. Accordingly, the information processing apparatus 10 can generate information necessary for the user's work with high accuracy.

As illustrated in FIG. 1, the one or more workflow servers 5-1 to 5-N are present on the network N. Any workflow server of the workflow servers 5-1 to 5-N may be referred to simply as “workflow server 5” in the following description. The workflow server 5 is an external system that is not included in the information processing system 100.

Examples of workflow tools provided by the workflow server 5 include Dify™, n8n™, dataiku®, and Power Automate®, which will be referred to by their trade names without distinguishing marks in the following description. The workflow tools may be selected as appropriate. An application programming interface (API) of a workflow executed by the workflow server 5 is registered in the information processing apparatus 10. The information processing apparatus 10 proposes a workflow. Examples of methods for determining workflows to be proposed are as follows:
proposing a workflow based on a chat history,
proposing a workflow used a relatively large number of times for document data selected from among search-adapted document data,
proposing a workflow used a relatively large number of times by an executing agent, and
proposing a workflow used a relatively large number of times by a department to which a user belongs.

The agent may be referred to, for example, as automatic response means, an artificial intelligence (AI) agent, a digital clone, a personalized AI, an AI assistant, an automatic response AI, a dialogue partner, an AI chatbot, a companion, a concierge, or a virtual interactive interface. The agent may be a virtual human displayed on the screen of the terminal apparatus 20 as a dialogue partner, for example, in the form of a three-dimensional (3D) avatar imitating a person.

The terminal apparatus 20 functions as a user interface of the information processing system 100. For example, the terminal apparatus 20 may be implemented by a personal computer (PC), a smartphone, or a tablet terminal apparatus. The terminal apparatus 20 receives an input message from a user and outputs output information corresponding to the input message. Examples of the input messages may include text, images, graphics, and audio. Examples of the output information may include response messages, images, graphics, and audio.

In the present embodiment, it is assumed that the information processing system 100 is operated by a certain company, which may be referred to as “company X” in the following description. The user who can access the information processing apparatus 10 is a person belonging to the company X, such as an employee of the company X. The service provided by the information processing apparatus 10 may be open to the public as a cloud service.

### Terms

The term “document data” refers to an electronically recorded document. However, the data format is not limited to a specific format. An example of document data is an electronic file, which may be referred to simply as a file in the following description.

The term “external system” refers to a separate system that operates independently of the information processing apparatus 10, provides data or a service, and cooperates with the information processing apparatus 10.

The external system may open, for example, an API, and the information processing apparatus 10 may perform communication by invoking the API. In the present embodiment, a workflow server is described as an example.

The term “external function” refers to a function of the external system. Specifically, the external function refers to a function of returning a result of processing on a network, such as an information processing service, a data processing service, a web service, or an AI service. In the present embodiment, the workflow corresponds to the external function. The term “workflow” refers to a process in which data and tasks flow through a system and are processed according to certain rules and procedures. The workflow is clearly defined in terms of input, output, and flow.

### Hardware Configuration

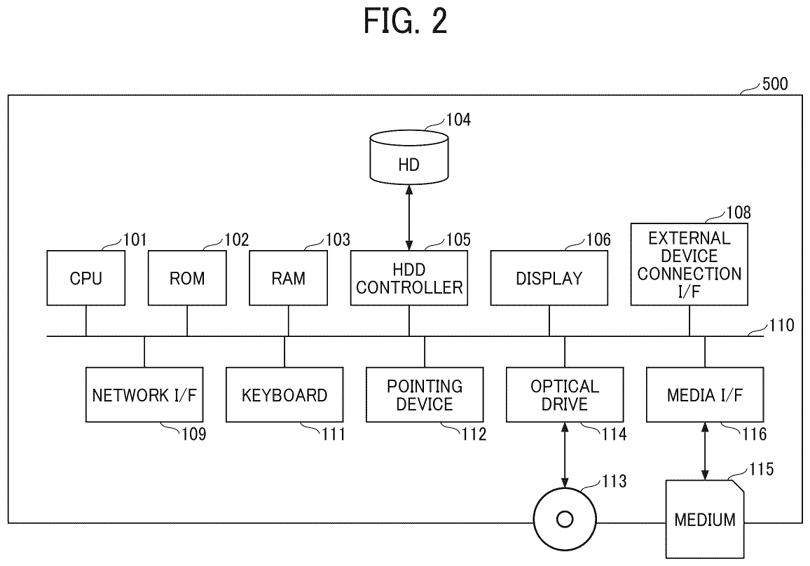

FIG. 2 is a diagram illustrating a hardware configuration of the information processing apparatus 10 or the terminal apparatus 20. As illustrated in FIG. 2, each of the information processing apparatus 10 and the terminal apparatus 20 is implemented by a computer 500. The computer 500 includes a central processing unit (CPU) 101, a read-only memory (ROM) 102, a random-access memory (RAM) 103, a hard disk (HD) 104, a hard disk drive (HDD) controller 105, a display 106, an external device connection interface (I/F) 108, a network I/F 109, a data bus 110, a keyboard 111, a pointing device 112, an optical drive 114, and a media I/F 116.

The CPU 101 controls the overall operation of the information processing apparatus 10. The ROM 102 stores a program such as an initial program loader (IPL) used for booting the CPU 101. The RAM 103 is used as a work area for the CPU 101. The HD 104 stores various data such as a program. The HDD controller 105 controls the reading of various data from, or the writing of various data to, the HD 104 under the control of the CPU 101. The display 106 displays various types of information, such as a cursor, a menu, a window, text, or an image. The external device connection I/F 108 is an interface for connection with various external devices. Examples of the external devices in this case include, but are not limited to, a universal serial bus (USB) memory and a printer. The network I/F 109 is an interface for data communication through a communication network. The data bus 110 is, for example, an address bus or a data bus, which electrically connects the components or elements such as the CPU 101 illustrated in FIG. 2.

The keyboard 111 is an example of an input device provided with multiple keys used for inputting characters, numerical values, and various instructions. The pointing device 112 is an example of an input device that allows selection or execution of various instructions, selection of a processing target, and movement of a cursor. The optical drive 114 controls the reading of various data from, or the writing of various data to, an optical storage medium 113, which is an example of a removable storage medium. The optical storage medium 113 may be, for example, a compact disc (CD), a digital versatile disk (DVD), or a Blu-ray™ disc. The media I/F 116 controls the reading of data from, or the writing (storing) of data to (in), a recording medium 115 such as a flash memory.

### Functions

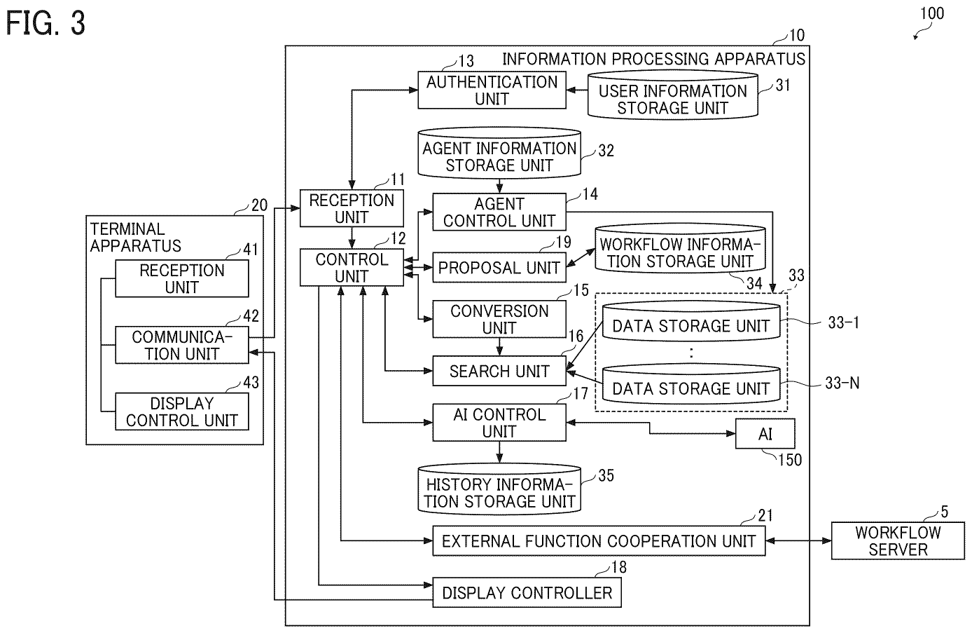

FIG. 3 is a diagram illustrating a functional configuration of the information processing system 100. Although the terminal apparatus 20 is illustrated in the information processing system 100 in FIG. 3, the terminal apparatus 20 is not necessarily included in the information processing system 100 provided that the terminal apparatus 20 is connected to the network N at least when the user interacts with the agent.

### Terminal Apparatus 20

The terminal apparatus 20 includes a reception unit 41, a communication unit 42, and a display control unit 43. These units are implemented by the CPU of the terminal apparatus 20 that execute processes according to the program installed on the terminal apparatus 20.

The reception unit 41 receives an operation performed by the user on the terminal apparatus 20.

The communication unit 42 controls communication with the information processing apparatus 10.

The display control unit 43 controls the display of screens, such as an interactive screen described later, based on information received from the information processing apparatus 10 such as display data.

The program executed by the terminal apparatus 20 may be a web application or a native application. The web application is an application in which a program on a web server and a program on a web browser cooperate to perform processing, and which does not have to be installed on the terminal apparatus 20. The web application is downloaded from the information processing apparatus 10. The native application is an application that is installed on the terminal apparatus 20 for use.

### Information Processing Apparatus 10

In FIG. 3, the information processing apparatus 10 includes some functional units and some storage units. FIG. 3 illustrates main functions used for interaction, and the information processing apparatus 10 may have functions other than those illustrated in FIG. 3. In addition, the connection lines between the functional units indicate main ones, and information may be exchanged between functional units without connection lines.

The information processing apparatus 10 includes, as functional units, a reception unit 11, a control unit 12, an authentication unit 13, an agent control unit 14, a conversion unit 15, a search unit 16, an AI control unit 17, a display control unit 18, a proposal unit 19, an external function cooperation unit 21, and an AI 150. The information processing apparatus 10 further includes a user information storage unit 31, an agent information storage unit 32, data storage units 33-1 to 33-N, a workflow information storage unit 34, and a history information storage unit 35. Any data storage unit of the data storage units 33-1 to 33-N may be referred to simply as “data storage unit 33” in the following description.

These functional units and the AI 150 of the information processing apparatus 10 are implemented by the CPU 101 that executes processes according to one or more programs installed on the information processing apparatus 10. The user information storage unit 31, the agent information storage unit 32, the data storage unit 33, the workflow information storage unit 34, and the history information storage unit 35 may be each implemented by, for example, the HD 104 or a storage device that can be connected to the information processing apparatus 10 via a network.

The AI 150 is a machine-learning model that has been trained to generate text in response to input text. Images, graphics, and audio may be input to the AI 150. The text input into the AI 150 is referred to as a “prompt.” In the present embodiment, a message input by a user is referred to as an “input message” to distinguish the input message from the prompt described later. The AI 150 generates, for example, text, images, graphics, or audio as response messages based on the input messages. The AI 150 is, for example, a generative AI using an LLM. The LLM is a natural language processing model trained on a vast amount of text data. The LLM receives a vast amount of text as input, and obtains knowledge from the input text by deep learning or reinforcement learning, for example. The LLM uses this knowledge to provide a response message to an input message. The input messages input to the large language model may include not only text such as instructions and questions but also files, images, graphics, and audio. The AI 150 that generates these pieces of information may be referred to as generative AI.

The LLM is used in many natural language processing (NLP) tasks, such as generation of a response to a specific question, automatic generation of a sentence, summarization of text, translation, and emotion analysis. Further, the LLM may be used in various fields such as education, entertainment, customer service, and product development. In the present embodiment, the text input by the user is the main input message. The AI 150 does not have to be operated on the information processing apparatus 10. For example, the AI 150 may be a generative AI that is open to the public, such as the one available on the Internet.

Machine learning is a technology for enabling computers to acquire human-like learning capabilities, and refers to a technique in which a computer autonomously generates algorithms necessary for decision-making, such as data classification, based on preloaded training data, and applies the generated algorithms to new data for prediction. The training methods for machine learning may include supervised learning, unsupervised learning, semi-supervised learning, reinforcement learning, deep learning, or any combination thereof, and the specific training method used for machine learning is not limited.

The reception unit 11 receives user input. For example, the reception unit 11 receives an input message for the agent as a dialogue partner. More specifically, the user input is performed on the terminal apparatus 20. The reception unit 11 thus receives the input message received by the terminal apparatus 20 from the terminal apparatus 20.

The control unit 12 controls interaction between the user and the agent. When the reception unit 11 receives a message input by the user, the control unit 12 controls the agent control unit 14, the conversion unit 15, the search unit 16, and the AI control unit 17 to generate a response message. The control unit 12 controls the display control unit 18 to cause the terminal apparatus 20 to display output information including the response message.

The conversion unit 15 converts the input message acquired from the control unit 12 into a vector that represents the meaning of the input message by a multi-dimensional numerical value. This vector may be referred to as a “semantic vector or message vector” in the following description. Such a semantic vector is referred to as a distributed representation. The distributed representation is a representation of text data by a fixed-length vector. The conversion to the distributed representation is performed by the existing embedding model. Although bidirectional encoder representations from transformers (BERT) and Doc2Vec are known as embedding models, the conversion into the distributed representation may be performed by any method.

Converting the original text into the distributed representation allows the meaning and content of the original text to be represented as numerical values, enabling comparison in vector data. In typical searches or comparisons using text data, even a single character difference could result in a mismatch, while a single character match could lead to an unintended hit. In contrast, comparing the pieces of information using vector data allows search for information based on the degree of similarity in meaning or content of the original text. Since the distributed representation is vector data, the original text can be represented as a point on a vector space. The similarity of the vector data can be calculated by an existing method such as cosine similarity.

When the embedding model converts the input message into a distributed representation, there may be an upper limit to the maximum length of the original text, and therefore the input message may also be divided into chunks, which will be described later.

The search unit 16 extracts, using the message vector generated by the conversion unit 15, a part of document data having a relatively high relevance to the message vector from among document data stored in the data storage unit 33. Although details will be described later, the document data stored in the data storage unit 33 is divided into chunks in advance, and chunk vectors obtained by converting the chunks into distributed representations are also stored. A chunk that is a source of a chunk vector similar to a message vector is referred to as a “similar chunk.” The search unit 16 acquires document data that is a source of the similar chunk from the data storage unit 33 as a part of the search result.

The agent control unit 14 controls switching between executing agents. An executing agent is an agent that is currently a dialogue partner of the user. This is because the agent is prepared for each role (specialized field) to generate a more accurate response message.

When the executing agent is selected by the user, the agent control unit 14 executes a process for setting the selected agent as the executing agent. When the executing agents are automatically switched according to the progress of the interaction, the control unit 12 determines whether an agent is present that can output a more appropriate response message than the current executing agent to the input message received by the reception unit 11 among multiple types of agents. When the control unit 12 determines that a more appropriate agent is present, the agent control unit 14 executes a process for setting the agent as an executing agent. The process for setting an agent as an executing agent includes changing the prompt and control rules according to the agent. When the data storage units 33-1 to 33-N to be searched differ depending on the executing agent, the agent control unit 14 designates the data storage units 33-1 to 33-N corresponding to the executing agent for the search unit 16.

The AI control unit 17 generates a prompt by inserting the input message received by the reception unit 11 and the set of similar chunks identified by the search unit 16 through a search into the system prompt. In other words, the AI control unit 17 generates a prompt by augmenting the input message received by the reception unit 11 with the set of similar chunks relevant to the search result by the search unit 16. The RAG may be used as a method for including the set of similar chunks in the prompt. The text of each chunk belonging to the set of similar chunks may be included in the prompt, or the chunk vector of the similar chunk may be included in the prompt. The following is a simple example of the system prompt.
<Example of system prompt begins.>
The input message from the user is as follows.
{Message}
Please generate a response to the input message by referring to the following document.
{Set of similar chunks relevant to search result}
<Example of system prompt ends.>

As described above, the system prompt includes explicitly defined sections for inserting an input message and for inserting a set of similar chunks identified by the search unit 16 through a search.

In this case, the AI control unit 17 generates a prompt by inserting the input message received by the reception unit 11 into the {message} section of the system prompt and inserting the set of similar chunks identified by the search unit 16 through the search into the {set of similar chunks relevant to search result} section of the system prompt. Inputting the prompt thus generated into the AI 150 allows the AI 150 to generate a response message based on even the information included in the set of similar chunks, which includes information that the AI 150 has not learned. In other words, the response message from the AI 150 may be based on the set of similar chunks relevant to the search result. The system prompt may include a text string for notifying the AI 150 of the role of an agent corresponding to the system prompt, such as “You are XXX.” (where XXX is a text string indicating the role).

In addition, in a case where the control procedure includes multiple phases, a system prompt may be defined in which a section into which an intermediate response acquired in a phase before a certain phase is inserted is clearly indicated. This intermediate response is, for example, an intermediate response obtained in any phase from the first to the (K-1)th phase preceding the Kth phase.

Further, each time a final response message is acquired from the AI 150, the AI control unit 17 stores the input message that is the source of the response message, the search result, the response message, the executing agent, and the executed workflow in the history information storage unit 35 in association with each other. An intermediate response message may also be stored together with the input message, the search result, the response message, the executing agent, and the executed workflow in association with each other. Accordingly, history information of interactions between the user and the agent, including input into and output from the AI 150, is stored in the history information storage unit 35.

The display control unit 18 transmits the output information to the terminal apparatus 20 to cause the terminal apparatus 20 to display various screens for displaying the output information. Since the display control unit 18 generates display data and transmits the display data to the terminal apparatus 20, the display control unit 43 of the terminal apparatus 20 performs actual display processing. The display data of the web application is, for example, HyperText Markup Language (HTML), Cascading Style Sheets (CSS), JavaScript®, JavaScript® Object Notation (JSON), or eXtensible Markup Language (XML). The display data of the native application is, for example, JSON or XML.

The output information includes a response message generated by the AI 150 to an input message from a user and search-adapted document data. For example, the display control unit 18 causes the terminal apparatus 20 to display a list of document data included in the response message or the search result acquired from the control unit 12.

The authentication unit 13 authenticates a user who operates the terminal apparatus 20 to log in to the information processing apparatus 10. The authentication unit 13 authenticates the user based on the authentication information, such as identification information of the user and a password, received by the reception unit 11. Other existing authentication methods, such as biometric authentication, may also be used. The authentication unit 13 may communicate with an external authentication server to authenticate the user.

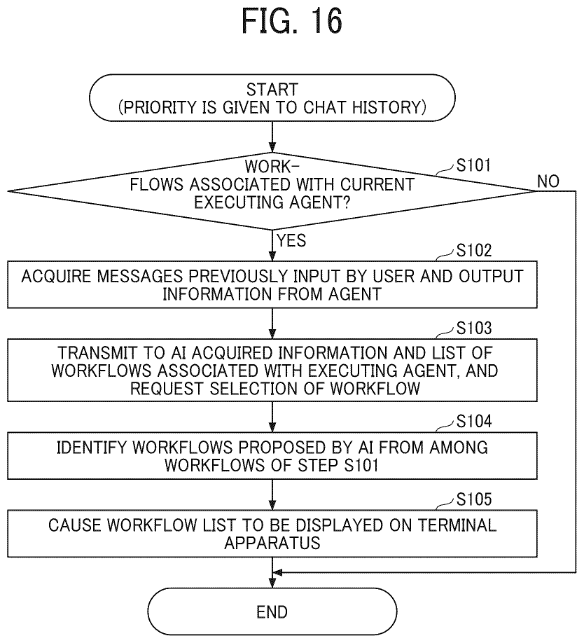

The proposal unit 19 proposes an optimal workflow to the user. The proposal unit 19 retains several methods for determining a workflow to be proposed. Details of the methods are described below with reference to FIGS. 16 to 19, which are flowcharts of determination methods in the case of the following (1) to (4), respectively:
(1) priority is given to a chart history, (2) priority is given to association with search-adapted document data, (3) priority is given to association with an executing agent, and (4) priority is given to association with a department to which a user belongs.

The timing of proposing a workflow may vary depending on the method for determining the workflow to be proposed. In the case of (1), the workflow is proposed when the agent determines that an appropriate workflow is present based on the input messages so far. In the case of (2), the workflow is proposed when the search-adapted document data is presented to the user. In the case of (3) the workflow is proposed when the executing agent is determined. However, in the case where the workflow uses a response message or document data, the workflow is proposed when the response message or document data is presented. In the case of (4), the workflow is proposed when the user logs in. However, in the case where the workflow uses a response message or document data, the workflow is proposed when the response message or document data is presented. The information processing apparatus 10 may simply propose a workflow associated with an agent.

The external function cooperation unit 21 invokes an API of the workflow selected by the user to cooperate with the workflow server 5 and request the execution of the workflow. The external function cooperation unit 21 retains the correspondence between a workflow identification (ID) and an API in advance. The external function cooperation unit 21 acquires the workflow execution result from the workflow server 5. The workflow execution result includes, for example, a response, options, data to be taken over next time, and a state to be taken over next time. The content of the response varies depending on the processing of the workflow, and may be, for example, a search result or a generated document.

### Data Storage Units

Various storage units included in the information processing apparatus 10 are described below with reference to, for example, FIG. 4. FIG. 4 is a diagram illustrating an example of chunk information stored in the data storage unit 33. The data storage units 33-1 to 33-N previously stores (registers) document data related to various operations of the company X. However, each of the data storage units 33-1 to 33-N stores a different set of document data. This is because the document data to be acquired differs depending on the role of the agent. For this reason, each of the data storage units 33-1 to 33-N may be prepared for each agent. The document data may be prepared for each agent in folders in the data storage units 33-1 to 33-N. In addition, some or all of the data storage units 33-1 to 33-N used by two or more agents may be the same.

Each of the data storage units 33-1 to 33-N is synchronized with a database. A database is a mechanism or system that enables efficient storage, management, search, and update of a large amount of data. Therefore, the database may be a simple storage or a server. For example, document data for business use are stored in the database. Commercial databases are also known, and the database may be a commercial database. Commercial databases include SharePoint®, BOX, and Dropbox.

The synchronization of the document data with the data storage units 33-1 to 33-N, that is, the registration of the document data in the data storage units 33-1 to 33-N from the database, may be performed in a batch manner, or may be manually performed by an administrator at any desired timing. Alternatively, the user may upload document data of the user. Each of the data storage units 33-1 to 33-N stores a document name, a document ID, a chunk, a chunk ID, and a chunk vector for each document data registered in the data storage unit 33. The document name is, for example, a file name. The document ID is identification information of the document data.

The chunk refers to a part of the document data acquired by dividing the document data in a predetermined unit. The unit of dividing the document data may be defined by the number of characters, the number of sentences, or a semantic unit (for example, a paragraph). The document data may be divided in units and stored in advance. A semantic vector obtained by converting each chunk into a distributed representation is a chunk vector.

The search unit 16 compares, for each document data in the data storage units 33-1 to 33-N to be searched, the message vector with the chunk vector relevant to the document data, and identifies a chunk corresponding to a chunk vector having a similarity equal to or higher than a certain value to the document data. This chunk is a similar chunk. The search unit 16 compares the similarities of the similar chunks and extracts the top M similar chunks having the highest similarities. Since multiple similar chunks may be found for one document data, N (<M) document data items are substantially extracted. The search unit 16 identifies the similar chunks so that the number of N is a predetermined number. To evaluate the similarity between the vectors, a cosine similarity may be used, or another index may be used.

The search unit 16 includes, in the search result, related document information including the top M similar chunks, chunk IDs stored in the data storage unit 33 in association with the similar chunks, and document IDs of the N document data items that are the sources of the similar chunks, and document names of the N document data items. The related document information may include document data. Each of the data storage units 33 may be managed based on a folder, a database, or any other management unit of document data.

### Agent Information Storage Unit

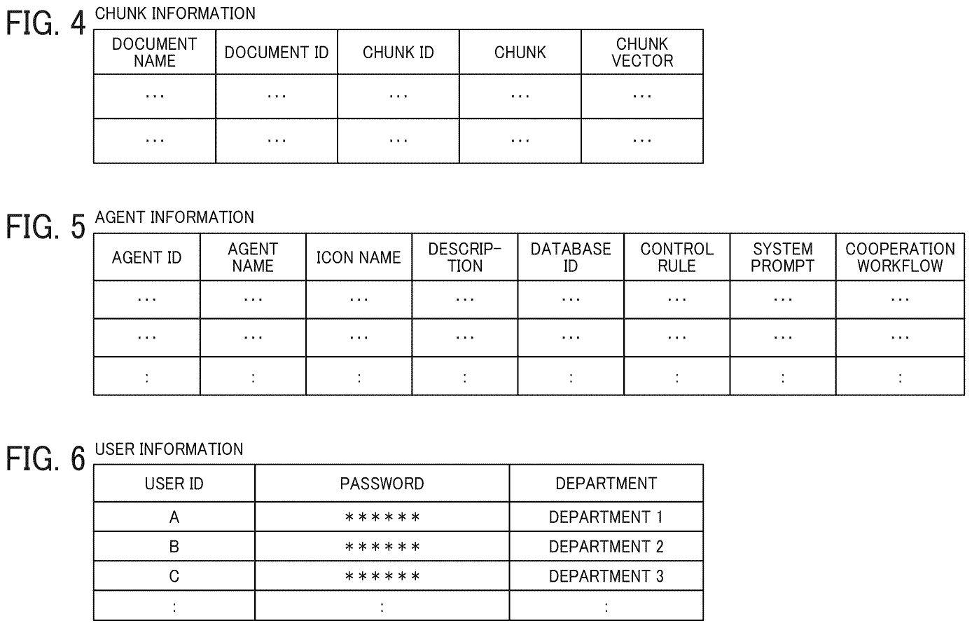

FIG. 5 is a diagram illustrating agent information stored in the agent information storage unit 32. As illustrated in FIG. 5, the agent information storage unit 32 stores in advance, for example, an agent ID, an agent name, an icon name, a description, a database ID, a control rule, a system prompt, and a cooperation workflow for each agent registered in the information processing apparatus 10.

The agent ID is identification information of the agent.

The agent name is the name of the agent.

The icon name is a file name of an icon representing the agent. The icon is displayed on an interactive screen, which is a screen for performing interaction between the user and the agent.

The description is text data describing, for example, the role of the agent in natural language.

The database ID is identification information of the data storage units 33-1 to 33-N to be searched by the agent. More specifically, the database ID is identification information of an external database. However, since the database corresponds to the data storage unit 33, the database ID may be regarded as identification information of the data storage units 33-1 to 33-N. Two or more data storage units 33 may be search targets.

The control rule and the system prompt are a control rule and a system prompt for causing the AI control unit 17 to correspond to the agent. Since the control rule and the system prompt are defined for each agent, multiple types of control rules and system prompts different from each other are prepared in advance. Such different control rules for each agent allow the agents to acquire distinct responses from the AI 150, even when searching the same database. In other words, the roles of the agents are implemented by the control rules and the system prompts. For example, for an agent having a role of outputting an inquiry response for generating a response message to a message input by the user, such as a question, a description describing that the agent has such a role, and a control rule and a system prompt for controlling the agent in such a manner are stored in association with the agent. For an agent having a role of analyzing data in response to an instruction from the user and outputting an analysis result, a description describing that the agent has such a role, and a control rule and a system prompt for controlling the agent in such a manner are stored in association with the agent.

The system prompt is a template of a prompt that is prepared in advance for each agent (for each role) and is input into the AI 150. For example, the prompt to be input into the AI 150 is generated by inserting the input message received by the reception unit 11 to the system template.

The control rule is data defining a procedure of input and output (interaction) of the AI 150, and is prepared in advance for each agent (for each role). To acquire a response to the message input by the user according to the roles of the executing agent, a single input of a prompt into the AI 150 is insufficient, and it may be necessary to cause the AI 150 to execute multiple tasks, such as extraction and categorization of specific information, prediction, and loop processing. In this case, a prompt needs to be input for each task. The control rule is data defining information indicating what kind of prompts are to be input into the AI 150 in what order (that is, the procedure of interaction with the AI 150). In the following description, the interaction with the AI 150 based on one control rule may be referred to as a “control procedure” whereas a single input of a prompt into the AI 150 in the control procedure may be referred to as a “phase.” When the control procedure includes multiple phases, a system prompt corresponding to each phase is prepared. In this case, the input message received by the reception unit 11 may be inserted into the system prompt of a certain phase. The system prompts of other phases may be filled with responses acquired prior to the phase in the control procedure. For the purpose of distinguishing between a response message acquired from the AI 150 in the middle of the control procedure and a response message finally acquired from the AI 150 in the control procedure (that is, a response message to an input message from the user), the former may be referred to as an “intermediate response message” and the latter may be referred to as a “final response message” in the following description. When a prompt needs to be input only once in the control procedure, the control rule includes one phase, and the number of system prompts is one. In this case, the final response message is acquired for a single prompt input, without an intermediate response message.

The cooperation workflow is a workflow registered in the agent. More specifically, the API of the workflow is registered. The external function cooperation unit 21 invokes the API to request the workflow server 5 to execute a predetermined workflow. The workflow is registered in the agent by, for example, an administrator. The administrator registers in advance a workflow that is considered to be effective for the agent, in consideration of the function of the agent. Multiple cooperation workflows may be registered in one agent. The agent is restricted to using only the workflows that are registered in the agent.

### User Information Storage Unit

FIG. 6 is a diagram illustrating an example of user information stored in the user information storage unit 31. FIG. 6 illustrates several items of user information for the description of the present embodiment. For example, the user information includes a password and a department registered in association with a user ID. The user ID and the password are referred to as authentication information. The authentication unit 13 determines whether the authentication is successful or unsuccessful by collating the authentication information transmitted from the terminal apparatus 20 with the authentication information in the user information storage unit 31.

### Workflow Information Storage Unit

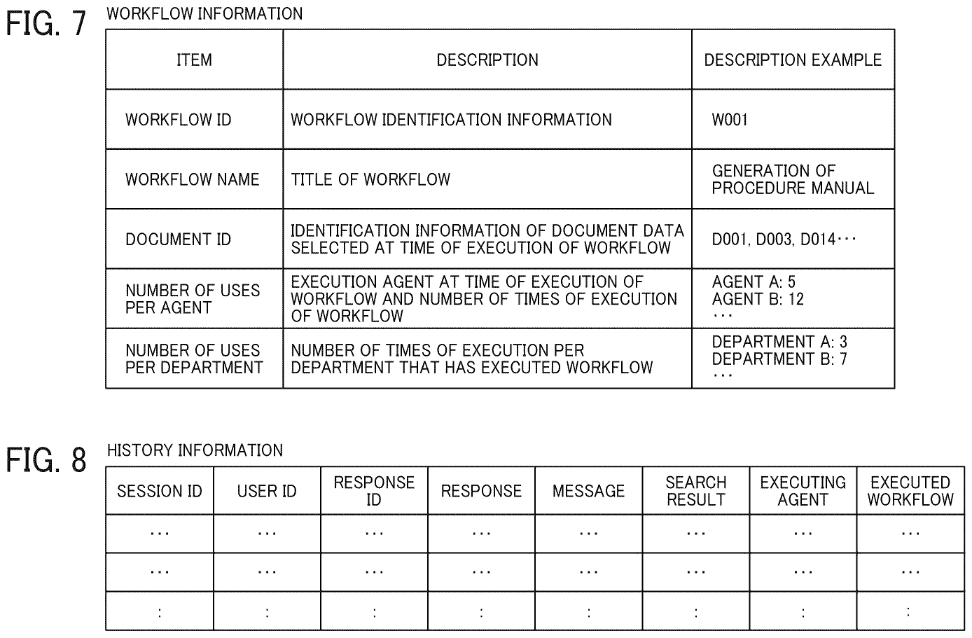

FIG. 7 is a diagram illustrating an example of workflow information stored in the workflow information storage unit 34. The workflow information is used, for example, to determine a workflow to be proposed. The workflow information is information obtained by totaling histories of the history information storage unit 35 described later.

The item “workflow ID” refers to identification information of a workflow.

The item “workflow name” refers to the name of the workflow, and is set by the administrator at the time of registration.

The item “document ID” refers to identification information (list) of document data selected by the user at the time of execution of the workflow. In other words, when the document data of the document ID is selected, the workflow may have been executed.

The term “number of uses per agent” refers to the executing agent at the time of execution of the workflow and the number of times of execution of the workflow under the executing agent. When the same agent is the executing agent, the workflow executed may also be the same. When the current executing agent is an agent having a relatively large number of uses per agent, the workflow associated with the current executing agent is highly likely to be executed.

The term “number of uses per department” refers to the department to which the user who has executed the workflow belongs and the number of times of execution of the workflow by one or more users at the department. Data processing on business required by users belonging to the same department may be the same. When the logged-in user is a user at the department having a relatively large number of uses per department, the workflow associated with the logged-in user is highly likely to be executed.

Although the number of times of execution of the workflow is recorded in association with the department to which the user belongs in FIG. 7, the number of times of execution of the workflow may alternatively be associated with each user.

### History Information Storage Unit

FIG. 8 is a diagram illustrating an example of history information stored in the history information storage unit 35. As illustrated in FIG. 8, the history information storage unit 35 stores history information including a session ID, a user ID, a response ID, an input message, a search result, an executing agent, and an executed workflow, for each final response from the AI 150.

The session ID is an ID unique to each session. The session refers to a series of exchanges of messages and responses between a user and an agent, which are performed from when an interactive screen 510 is displayed to when the interactive screen 510 is closed. The responses are the final responses, or may include the final responses and the intermediate responses. The same session ID is assigned to the final responses output in the same session.

The user ID is identification information of the user who has performed the session (interaction) relevant to the session ID. The user ID is identified as a result of user authentication.

The response ID is, for example, an ID unique to each final response. The response ID is given, for example, when the AI control unit 17 records the final response in the history information storage unit 35.

The response is the final response message from the AI 150.

The message and the search result are an input message, a response message, and a search result inserted into the prompt that is the source of the final response.

The executing agent is an agent responsible for the interaction during the session. Multiple executing agents may be set.

The executed workflow is a workflow executed during the session. Multiple executed workflows may be set.

For example, the information of “document ID” in the workflow information in FIG. 7 is obtained by extracting the document ID and the executed workflow included in the search result of the history information. The “number of uses per agent” in the workflow information is obtained by extracting the executing agent and the executed workflow from the history information and adding the number of times of extraction of the executing agent. The “number of uses per department” in the workflow information is obtained by extracting the user ID from the history information to identify the department to which the user belongs, extracting the executed workflow from the history information, and adding the number of times of extraction of the department.

### Workflow Tool

This section describes the workflow tool. As an example, Dify, which is one of the workflow tools, is described below. The workflow tool is a platform that facilitates creation, management, and deployment of applications utilizing AI. The workflow tool is designed to build customizable workflows that utilize AI models, such as large language models. The created workflow may be referred to as an application. The workflow tool is a no-code or low-code development tool that facilitates creation of applications by a drag-and-drop operation. Therefore, the workflow tool can be used even without advanced knowledge and skill regarding application development and programming. The created workflow may include a single process.

The workflow tool is also integrated with various AI models, such as Claude3, GPT, DALL-E, and PythonAI. The AI models can be incorporated into the created workflow. The workflow tool can also utilize RAG. Utilizing RAG enables rapid execution of tasks, such as text extraction from documents including portable document format (PDF) documents, data ingestion, and search operations.

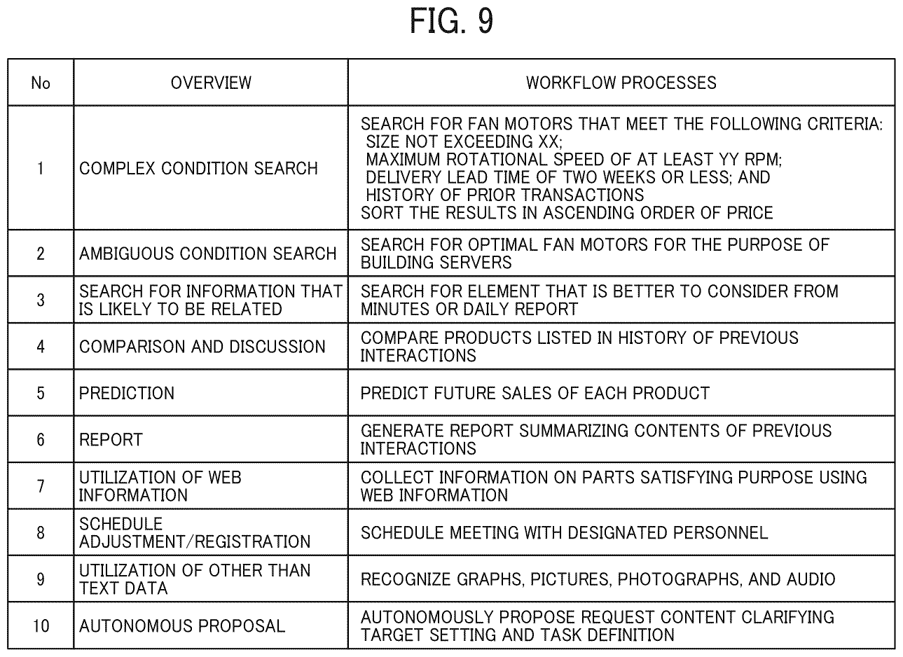

FIG. 9 illustrates processes performed by the workflow tool. According to the illustration of FIG. 9, the workflow tool allows the creation of workflows for executing various operations, such as searches, comparisons, predictions, document generation, schedule adjustment, information recognition, and proposals. In addition, a workflow convenient for performing business operations is conceivable, such as development of a customer support bot, content generation, language translation, and determination of a person in charge suitable for a task.

FIG. 9 illustrates each process in one or two lines in natural language. However, when a user intends to implement a process through interaction with the interactive AI, the user needs to input a message and receive a response message output in response to the message. In addition, the display format and quality of the output information finally output by the information processing apparatus 10 often do not reach the level expected by the user. The workflow server 5 performs processing based on the workflow definition set in advance, and thus can generate information at a level expected by the user. In the present embodiment, the information processing apparatus 10 proposes an optimal workflow in the interaction with the user, so that the user can instruct an execution request of an appropriate workflow in the interaction with the agent.

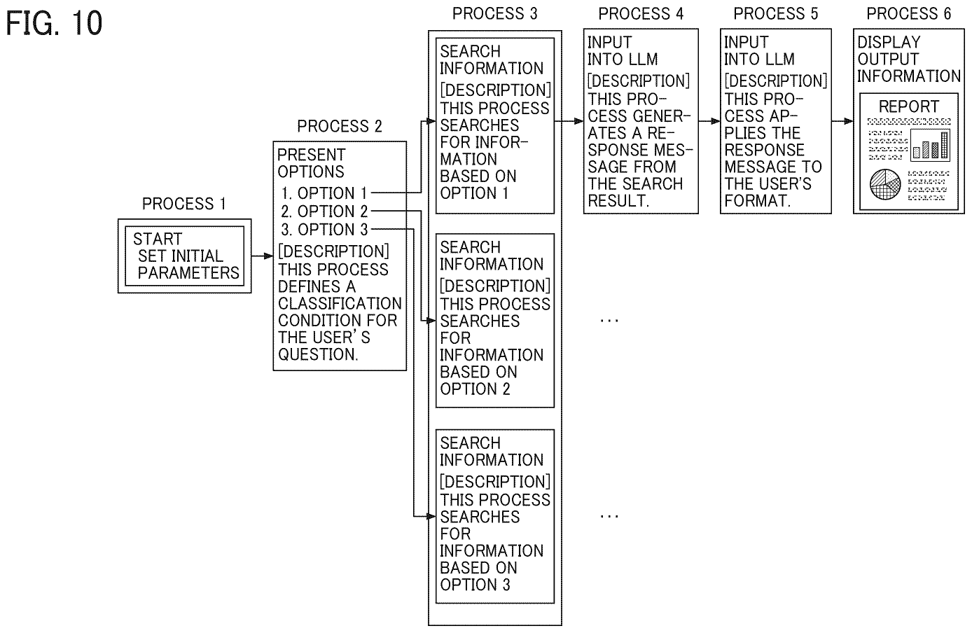

FIG. 10 is a simplified diagram illustrating a workflow definition performed by the workflow tool. The workflow definition refers to the content of the processes performed by the workflow tool as illustrated in FIG. 10. The actual workflows are often more complex.

In Process 1, the workflow server 5 sets initial parameters necessary for the workflow. The initial parameters may be various, such as variables that store information selected or input by the user.

In Process 2, the workflow server 5 presents options to the user. Options 1 to 3 are displayed on the terminal apparatus 20.

Process 3 branches according to the option selected by the user. A case where Option 1 is selected is described below. Process 3 is a searching process.

In Process 4, the workflow server 5 inputs, for example, the search result to the LLM to generate a response message.

In Process 5, the workflow server 5 formats the response message by, for example, applying the response message to the user's format.

In Process 6, the information processing apparatus 10 causes the terminal apparatus 20 to display the response information generated by the workflow server 5, such as a report formatted in a display format unique to the user.

The information processing apparatus 10 displays the response information acquired from the workflow server 5 on the interactive screen on which the user has interacted with the agent. In other words, the response information acquired from the workflow server 5 is displayed seamlessly following the response message. This obviates the user's need to be aware of changes of the dialogue partners. Indicators such as icons enable identification of the dialogue partner as the workflow servers 5.

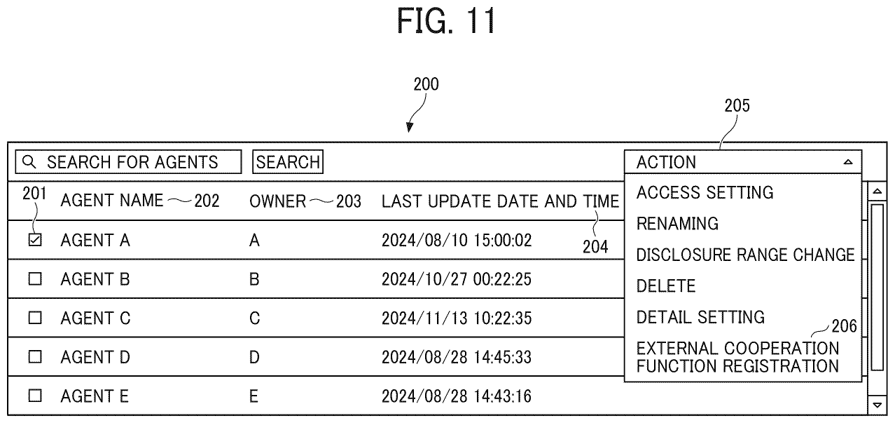

FIG. 11 is a diagram illustrating a registration screen 200 for registering a workflow in an agent. The registration screen 200 displays information on one agent for each row. The information on each agent includes a checkbox 201, an agent name 202, an owner 203, and a last update date and time 204. The administrator selects an agent whose workflow is to be registered by pressing a checkbox 201.

An action selection button 205 is displayed on the upper right of the registration screen 200. When the action selection button 205 is pressed, a pull-down menu is displayed. The pull-down menu includes an external cooperation function registration 206. When the administrator presses the external cooperation function registration 206, the screen transitions to a screen for registering an external function (workflow).

### Operations and Processes

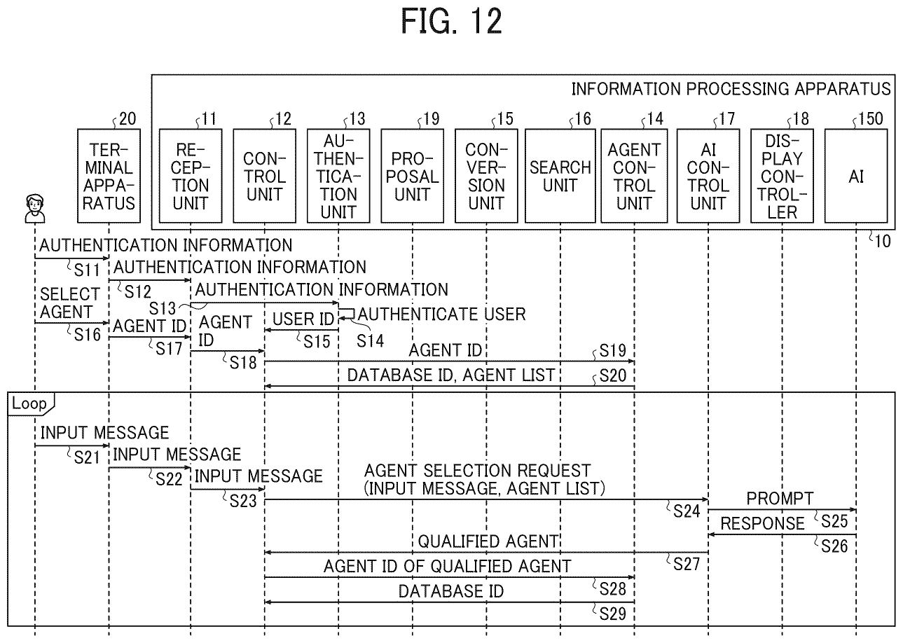

Operations and processes executed by the information processing system 100 are described below with reference to FIG. 12. FIG. 12 is a sequence diagram illustrating operations and processes executed by the information processing system 100.

In step S11, a user who wants to make an inquiry to an agent logs in to the information processing apparatus 10. The user inputs authentication information into the terminal apparatus 20, and the reception unit 41 receives the input of the authentication information.

In step S12, the communication unit 42 transmits an authentication request to the information processing apparatus 10 together with the authentication information.

In step S13, in response to the authentication information, the reception unit 11 of the information processing apparatus 10 transmits the authentication information to the authentication unit 13.

In step S14, the authentication unit 13 authenticates the user based on the authentication information. It is assumed that the authentication is successful. The user ID is identified as a result of successful authentication.

In step S15, the authentication unit 13 transmits the user ID identified as a result of successful authentication to the control unit 12.

In step S16, the user selects an agent from a list of selectable agents displayed on an executing agent selection screen, which is displayed on the terminal apparatus 20 as a result of successful authentication, and the reception unit 41 of the terminal apparatus 20 receives the selection.

In step S17, the communication unit 42 transmits an agent ID as identification information of the selected agent to the information processing apparatus 10.

In step S18, in response to the agent ID, the reception unit 11 of the information processing apparatus 10 transmits the agent ID to the control unit 12.

In step S19, the control unit 12 transmits the agent ID to the agent control unit 14, to notify the agent control unit 14 of the executing agent. More specifically, a qualified agent may be the executing agent.

In step S20, the agent control unit 14 acquires agent information corresponding to the transmitted agent ID from the agent information storage unit 32. The agent control unit 14 returns the database ID associated with the agent ID acquired from the agent information storage unit 32 and the agent list to the control unit 12. The agent list is a list of agents stored in the agent information storage unit 32. The agent control unit 14 returns the agent list to select an agent appropriate for a message input by the user. In addition, the agent control unit 14 sets the control rule and the system prompt of the agent information to the AI control unit 17 via the control unit 12.

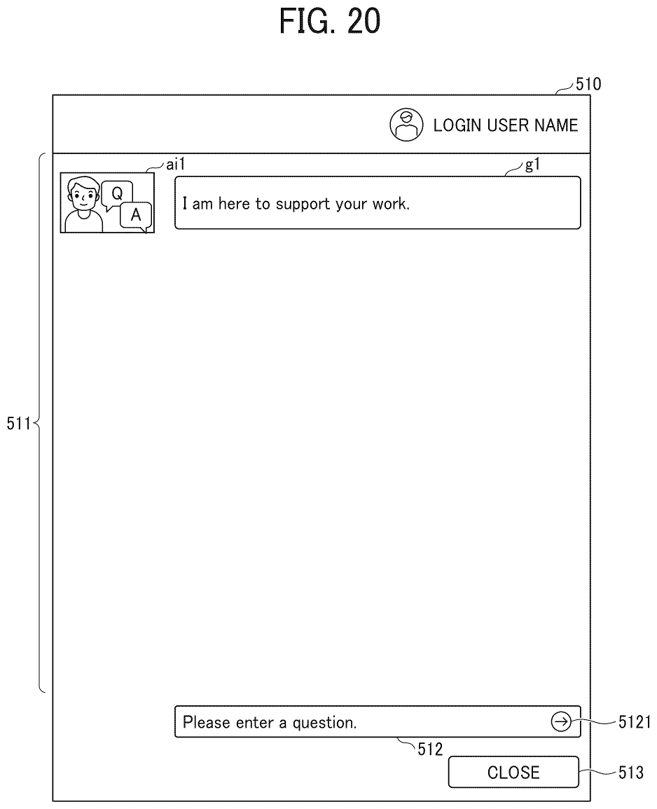

In step S21, the user inputs a message into a message input area of an interactive screen and clicks a send icon 5121 (see FIG. 20). The reception unit 41 of the terminal apparatus 20 receives these operations.

In step S22, the communication unit 42 of the terminal apparatus 20 transmits the input message to the information processing apparatus 10.

In step S23, in response to the input message, the reception unit 11 of the information processing apparatus 10 transmits the input message to the control unit 12.

In step S24, in response to the input message, the control unit 12 transmits an agent selection request to the AI control unit 17. The agent selection request includes an input message and the agent list. The agent selection request refers to a request for selecting an agent qualified for generating a response message to the input message. Being qualified for generating a response message refers to being able to output the most appropriate response message to the input message.

In step S25, the AI control unit 17 generates a prompt for instructing the AI 150 to select a qualified agent based on the input message, the agent list, and a system prompt prepared in advance for selection of a qualified agent, and transmits the generated prompt to the AI 150. The prompt generated at this time is a prompt requesting the AI 150 to select an agent having a role capable of generating an appropriate response message to an input message from the user from among multiple agents having different roles. In other words, the prompt is a prompt that causes the AI 150 to determine the type of the response message requested by the user based on the message input by the user, and causes the AI to determine an agent that can generate the response message of the type based on the role of each agent.

The following is a simple example of the system prompt.
<Example of system prompt begins.>
The input message from the user is as follows.
{Message}
The following are candidates for an agent to respond to the above input message:
{List of agent IDs and agent descriptions}
Select an agent that can output the most appropriate response to the above input message from among the above agents, and output the agent ID of the agent.

<Example of system prompt ends.>

In this case, the AI control unit 17 generates a prompt by inserting the input message to the {message} section of the system prompt and inserting the agent ID and the description of the agent (that is, the role of the agent) to the {list of agent IDs and agent descriptions} section for each agent.

In step S26, the AI 150 into which the prompt generated as described above is input selects a qualified agent from among the agents listed in the prompt based on the learned parameters, and generates a response message including the agent ID of the selected agent. The AI 150 transmits the response message to the AI control unit 17. The AI control unit 17 receives the response from the AI 150. The response message includes the agent ID of the agent selected as the qualified agent.

In step S27, the AI control unit 17 transmits the agent ID of the qualified agent to the control unit 12. The agent designated by the user or the qualified agent is the executing agent. Although the agents are automatically switched in the sequence diagram of FIG. 12, the executing agent may alternatively be fixed when the user does not desire automatic switching between the agents. To fix the executing agent, for example, the user may give instructions by inputting a message, or pressing a button on the interactive screen.

In step S28, the control unit 12 transmits the agent ID of the qualified agent to the agent control unit 14. The agent control unit 14 compares the agent ID of the qualified agent output by the AI control unit 17 with the agent ID selected by the user. When the agent IDs are the same, the agent control unit 14 proceeds to responding to the input message. By contrast, when the agent IDs are different from each other, the agent control unit 14 executes the same processing following step S19 in which the agent control unit 14 receives the agent ID again. Specifically, the agent control unit 14 sets the control rule and the system prompt of the agent information to the AI control unit 17 via the control unit 12 again.

In step S29, the agent control unit 14 returns the database ID associated with the agent ID, which is acquired from the agent information storage unit 32, to the control unit 12.

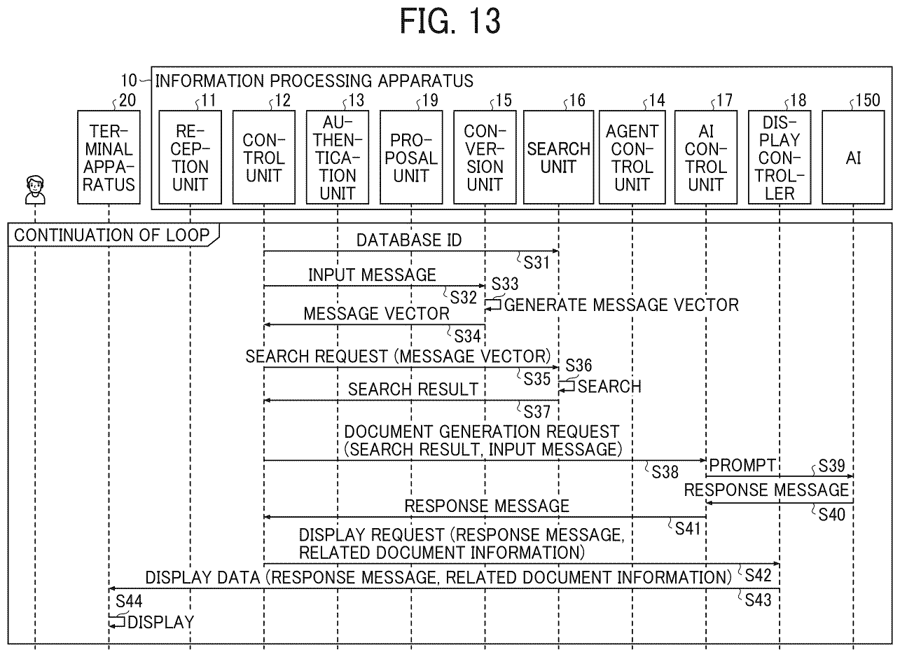

FIG. 13 is a sequence diagram illustrating operations and processes executed by the information processing system 100 in relation to responding to an input message.

In step S31, the control unit 12 transmits the database ID acquired from the agent control unit 14 to the search unit 16. As a result, the search unit 16 searches the data storage unit 33 corresponding to the executing agent.

In step S32, the control unit 12 transmits the message input by the user to the conversion unit 15.

In step S33, the conversion unit 15 converts the input message into a message vector.

In step S34, the conversion unit 15 returns the message vector to the control unit 12.

In step S35, the control unit 12 transmits a search request to the search unit 16 together with the message vector.

In step S36, the search unit 16 identifies a database based on the database ID transmitted in step S31, identifies the data storage unit 33 synchronized with the database, and searches for a chunk vector stored in the data storage unit 33 based on the message vector. The search unit 16 identifies a chunk vector having a relatively high similarity to the message vector, and extracts a similar chunk that is a source of the chunk vector. For example, the search unit 16 extracts the similar chunks that are the sources of the top M chunk vectors having relatively high similarities to the message vector. The search unit 16 generates a search result including the related document information, which includes the top M similar chunks, the chunk IDs corresponding to the similar chunks, the document IDs of N document data items that are the sources of the similar chunks, and the document names of the N document data items. The document data may be referred to as “search-adapted document data.”

In step S37, the search unit 16 transmits the search result to the control unit 12.

In step S38, the control unit 12 transmits a document generation request to the AI control unit 17 together with the input message and the search result, which includes the similar chunks, the document IDs of the N document data items that are the sources of the similar chunks, and the document names of the N document data items.

In step S39, the AI control unit 17 generates a prompt based on the received search result and input message, and the control rule and system prompt. The AI control unit 17 transmits the prompt to the AI 150.

In step S40, the AI control unit 17 receives, from the AI 150, a response message generated by the AI 150 into which the prompt is input. Depending on the control procedure, the first response may not be the final response. In this case, the final response message is obtained by repeating steps S39 and S40 multiple times.

In step S41, the AI control unit 17 transmits the generated response message to the control unit 12.

In step S42, the control unit 12 transmits to the display control unit 18 a display request of output information including the response message and the related document information included in the search result.

In step S43, the display control unit 18 causes the output information to be displayed on the interactive screen, which is displayed on the terminal apparatus 20. Specifically, the display control unit 18 generates display data for displaying the output information and transmits the generated display data to the terminal apparatus 20, thereby causing the display data to be displayed on the interactive screen 510.

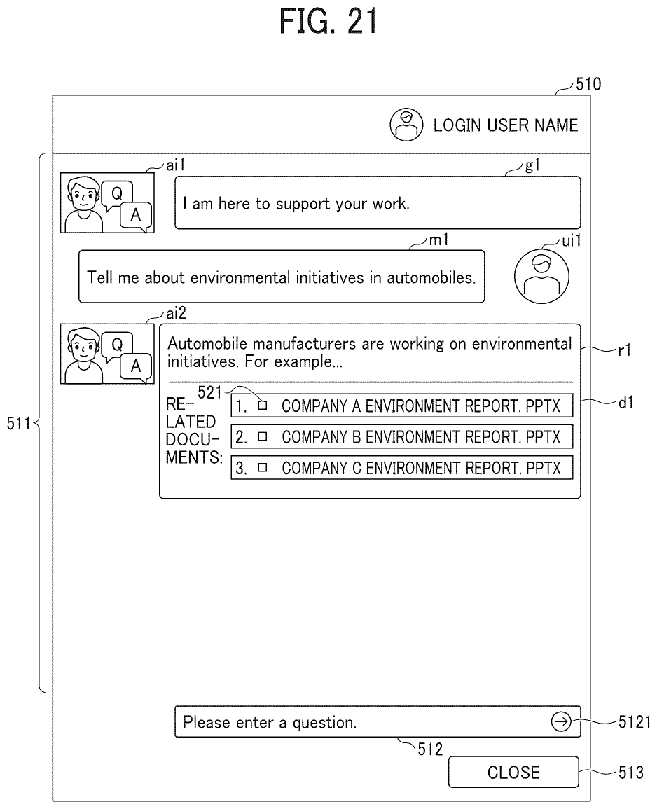

In step S44, the communication unit 42 of the terminal apparatus 20 receives the display data, and the display control unit 43 displays the output information (see FIG. 21).

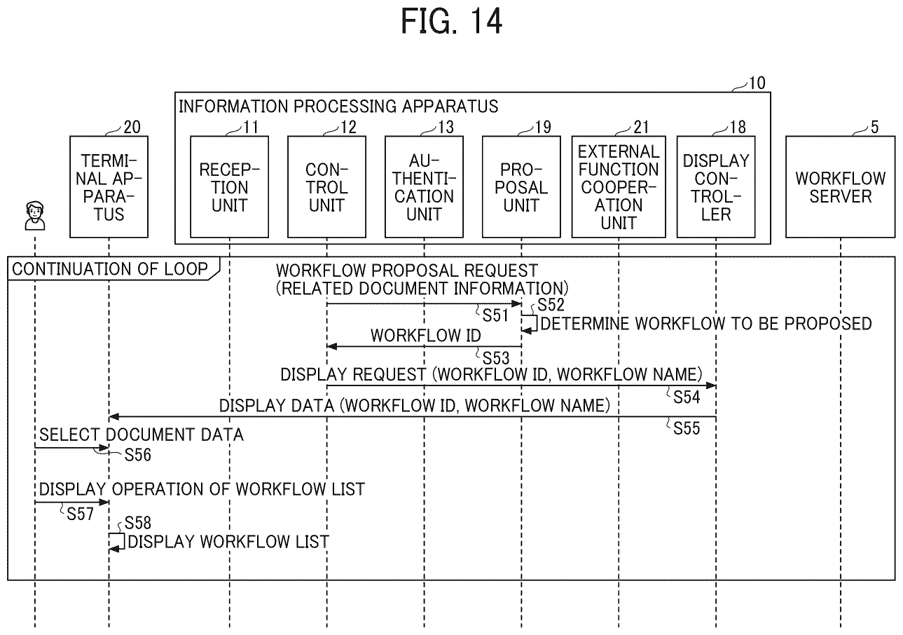

FIG. 14 is a sequence diagram illustrating operations and processes executed by the information processing system 100 in relation to workflow proposal.

The timing of proposing a workflow differs depending on the cases (1) to (4) described above. In the case of (1), the workflow can be determined each time after a message is input by a user. In the case of (2), the workflow can be determined after document data is identified through a search. In the case of (3), the workflow can be determined after an executing agent is determined. In the case of (4), the workflow can be determined after the user logs in and the department to which the user belongs is identified. After the workflow is determined, the information processing apparatus 10 may propose the workflow at any desired timing. In the following description, it is assumed that a workflow is proposed together with document data. After the search result is acquired, in step S51, the control unit 12 transmits a workflow proposal request to the proposal unit 19 together with the related document information. Specifically, the operation of step S51 can be executed after step S37, and the workflow to be proposed may be transmitted to the terminal apparatus 20 together with the output information displayed in step S44.

In step S52, the proposal unit 19 determines a workflow to be proposed by performing at least one of the processes described later with reference to FIGS. 16 to 19. The processes illustrated in FIGS. 16 to 19 correspond to the cases of (1) to (4) described above.

The user may set in advance which of the determination methods in the cases of (1) to (4) is used to determine the workflow, or may give an instruction in the interaction. When workflows are determined by multiple determination methods in the cases of (1) to (4), the proposal is made so that one or more workflows determined by each determination method are included. The proposal unit 19 may simply propose a workflow associated with an executing agent. When a relatively small number of workflows are associated with the executing agent, selecting a workflow from a list may hardly be a workload for the user.

In step S53, the proposal unit 19 returns one or more workflow IDs of the determined one or more workflows to the control unit 12.

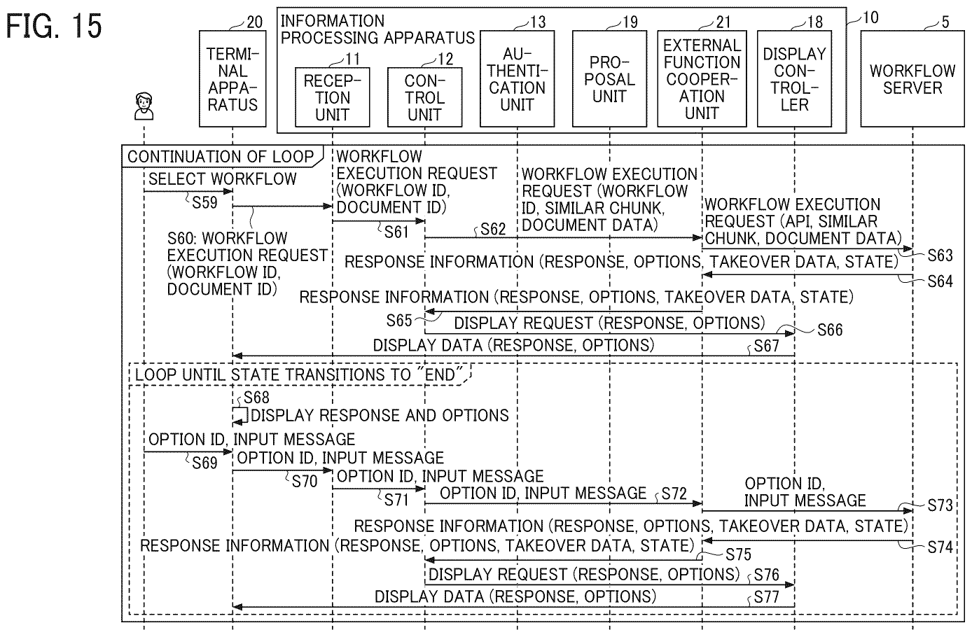

In step S54, the control unit 12 transmits a display request to the display control unit 18 together with the one or more workflow IDs and workflow names so that the user can select a workflow. In step S54, the control unit 12 causes the workflow names to be displayed on the terminal apparatus 20. However, a single workflow is determined to be proposed, the process may proceed to step S62 of FIG. 15 to initiate execution of the workflow.

In step S55, the display control unit 18 transmits display data to the terminal apparatus 20 so that the workflow names can be displayed on the interactive screen, which is displayed on the terminal apparatus 20. The workflow names are displayed, for example, when the user selects document data. Alternatively, the workflow names may be displayed on the interactive screen when the display control unit 18 transmits the display data to the terminal apparatus 20.

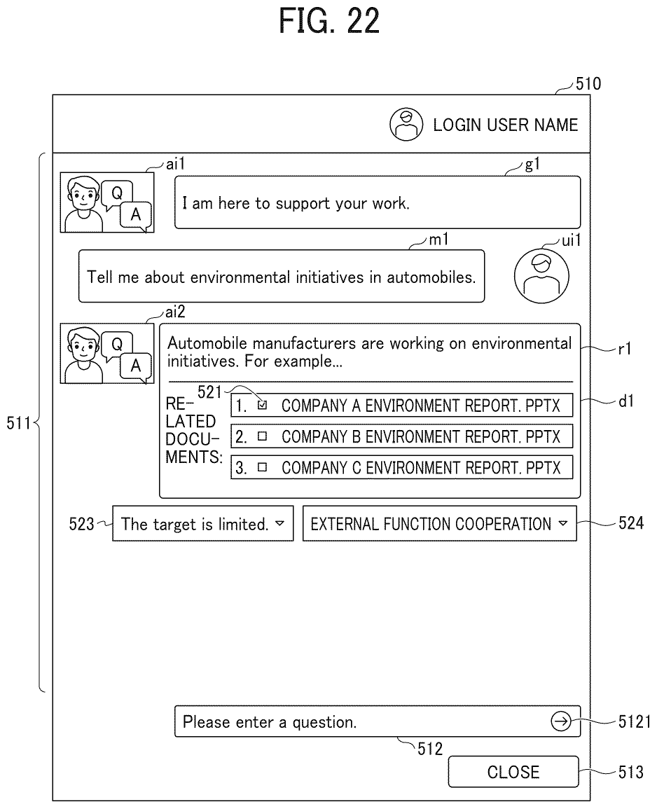

In step S56, the user selects document data displayed on the interactive screen in step S44 (see FIG. 22). Although there are various ways how the user utilizes the document data, the document data is used for execution of the workflow in the present embodiment. The reception unit 41 receives the selection.

In step S57, the user performs a display operation of a workflow list, which is an operation to cause a workflow list to be displayed. The workflow list may be displayed without the display operation.

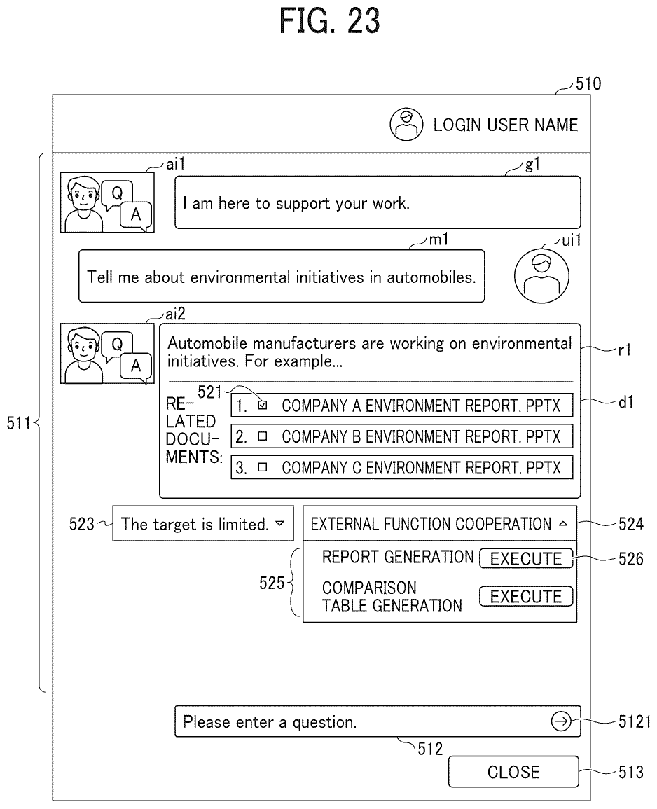

In step S58, in response to the display operation of the workflow list, the display control unit 43 displays a list of the workflows transmitted in step S54 (see FIG. 23). At this time, the display control unit 43 may display each workflow in association with which of the determination methods in the cases of (1) to (4) the workflow has been proposed by.

FIG. 15 is a sequence diagram illustrating operations and processes executed by the information processing system 100 in relation to workflow execution.

In step S59, the user selects a workflow when the user wants to process the selected document data through the workflow. The reception unit 41 receives the selection.

In step S60, the communication unit 42 of the terminal apparatus 20 transmits a workflow execution request to the information processing apparatus 10 together with the workflow ID and the document ID of the selected document data.

In step S61, the reception unit 11 of the information processing apparatus 10 receives the workflow execution request. The reception unit 11 transmits the workflow execution request to the control unit 12 together with the workflow ID and the document ID.

In step S62, the control unit 12 identifies the document data based on the document ID, and acquires the similar chunk of the document data included in the related document information. The control unit 12 transmits the workflow execution request to the external function cooperation unit 21 together with the workflow ID, the similar chunk, and the document data. The document data may not be transmitted because the similar chunk is transmitted.

In step S63, the external function cooperation unit 21 identifies an API based on the workflow ID and invokes the API from the workflow server 5. The external function cooperation unit 21 requests the workflow server 5 to execute the workflow together with the document data and the similar chunk via the API. The external function cooperation unit 21 may also transmit to the workflow server 5, for example, a tenant ID, a user ID, a session ID, and a language code for internal processing.

In the present embodiment, the workflow is triggered by the user selecting document data. However, the workflow can be executed without the user selecting document data. In this case, the external function cooperation unit 21 transmits a response message or an input message to the workflow server 5 instead of the document data and the similar chunk. In other words, input of at least one among the document data, the response message, and the input message into the AI 150 is sufficient.

When an error occurs at the time of invoking the API, the display control unit 18 causes the terminal apparatuses 20 to display an error message such as “We are currently undergoing maintenance. We apologize for the inconvenience and appreciate your patience.” and the external function cooperation unit 21 ends the execution of the external function. When the external function cooperation unit 21 acquires an error code from the workflow server 5, the external function cooperation unit 21 causes an error message corresponding to the error code to be displayed. For example, “error code E02: API call timeout occurred (XXX seconds)” is displayed.

In step S64, the workflow server 5 executes processing based on the workflow definition of the workflow requested to be executed. The external function cooperation unit 21 acquires response information, which includes a response, options, data to be taken over next time, and a state to be taken over next time, from the workflow server 5. The response is a response message generated by the workflow server 5. The options are set in the workflow definition. The data to be taken over next time is information transmitted to the workflow server 5 from the start of the workflow execution request to the current time and response information. The state to be taken over next time indicates which state in the workflow definition (that is, to which extent the process has progressed).

In the execution of one workflow, multiple exchanges may occur between the user and the workflow server 5. The user confirms the response information and inputs a message (including the selection result of the option). The workflow server 5 advances the processing based on the input message and the workflow definition. The workflow server 5 repeats the acquisition of the input message and the transmission of the response information until the workflow is completed.

In step S65, the external function cooperation unit 21 relays the response information to the control unit 12.

In step S66, the control unit 12 designates the response and the options and transmits a display request to the display control unit 18 so that the response and the options included in the response information are displayed on the interactive screen.

In step S67, the display control unit 18 transmits display data to the terminal apparatus 20 so that the response and the options can be displayed on the interactive screen, which is displayed on the terminal apparatus 20.

The first response between the information processing apparatus 10 and the workflow server 5 is completed as described above. Since the user and the workflow server 5 exchange information with each other multiple times as described above, the information processing system 100 repeats the following processing until the workflow definition state transitions to “end.”

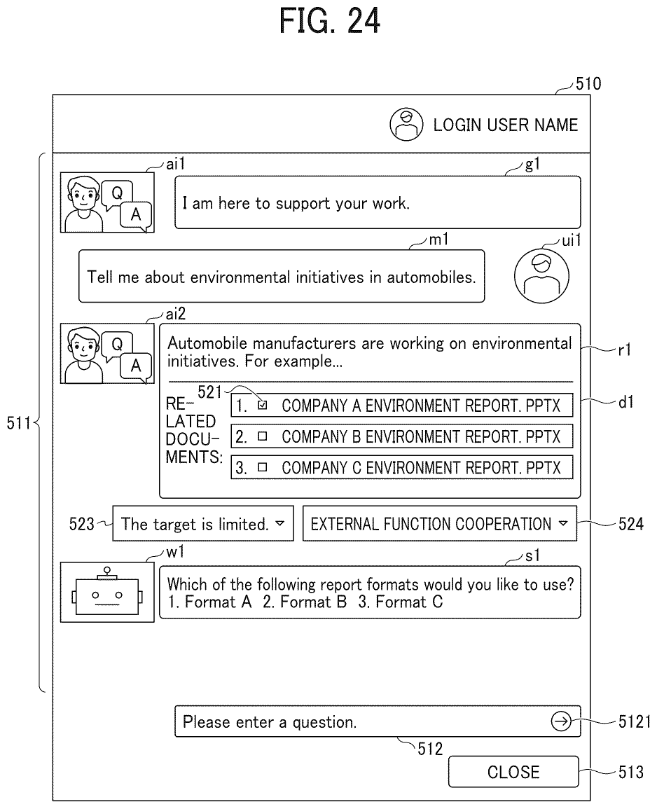

In step S68, the display control unit 43 of the terminal apparatus 20 displays the response and the options on the interactive screen (see FIG. 24). Thus, the response and the options from the workflow server 5 are displayed seamlessly with the output information of the interactive AI.

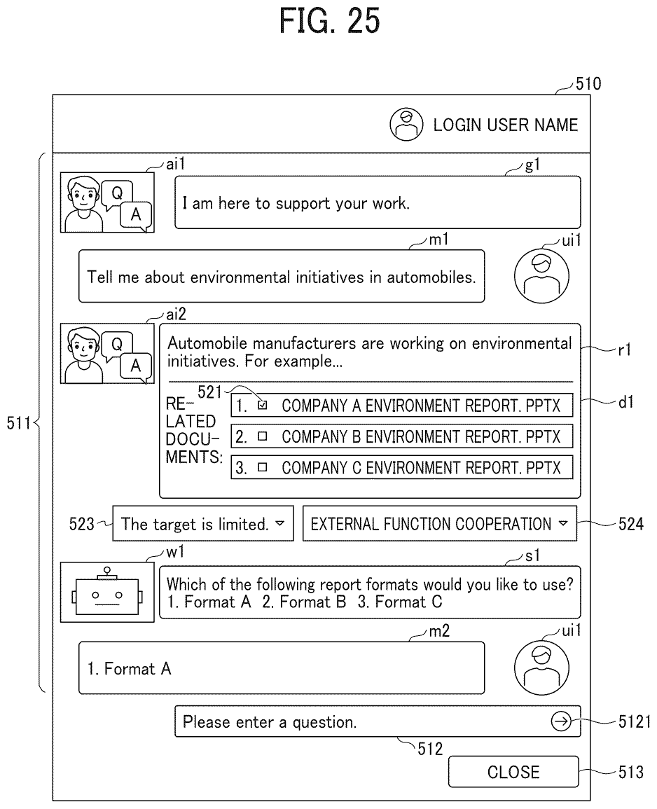

In step S69, the user selects one of the available options, if any are presented, and inputs a message as necessary (see FIG. 25). The identification information of the selected option may be referred to as “option ID.”

The reception unit 41 receives these inputs.

In step S70, the communication unit 42 of the terminal apparatus 20 transmits the option ID and the input message to the information processing apparatus 10.

In step S71, the reception unit 11 of the information processing apparatus 10 receives the option ID and the input message. The reception unit 11 transmits the option ID and the input message to the control unit 12.

Since the workflow definition state has not transitioned to “end,” in step S72, the control unit 12 transmits the option ID and the input message to the external function cooperation unit 21.

In step S73, the external function cooperation unit 21 invokes an API from the workflow server 5, and transmits the option ID and the input message to the workflow server 5 via the API. The external function cooperation unit 21 also transmits to the workflow server 5, for example, the tenant ID, the user ID, the session ID, and the language code for internal processing. When invoking the API for the second time or later, the external function cooperation unit 21 also transmits the takeover data and the current state to the workflow server 5. Based on the takeover data and the current state, the workflow server 5 can recognize the past data and the current state of the workflow definition.

In step S74, the workflow server 5 executes a process based on the workflow definition to be executed, the option ID, and the input message. The external function cooperation unit 21 acquires response information, which includes a response, options, data to be taken over next time, and a state to be taken over next time, from the workflow server 5. The operations of the following steps S75 to S77 are similar to those of steps S65 to S67.

In step S75, the external function cooperation unit 21 relays the response information to the control unit 12.

In step S76, the control unit 12 designates the response and the options and transmits a display request to the display control unit 18 so that the response and the options included in the response information are displayed on the interactive screen.

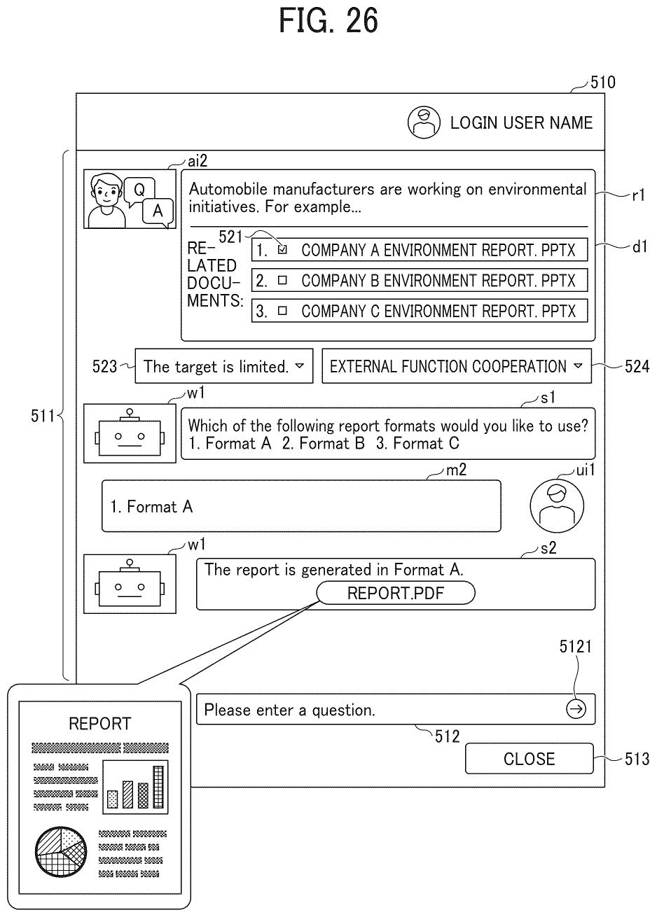

In step S77, the display control unit 18 transmits display data to the terminal apparatus 20 so that the response and the options can be displayed on the interactive screen, which is displayed on the terminal apparatus 20. The display control unit 43 of the terminal apparatus 20 displays the response and the options on the interactive screen until the workflow state transitions to “end,” and displays the execution result when the workflow state transitions to “end” (see FIG. 26).

Methods for Determining Workflows To Be Proposed

Methods for determining workflows to be proposed are described below with reference to FIGS. 16 to 19. FIG. 16 is a flowchart of a determination method when (1) priority is given to a chart history. Although the process illustrated in FIG. 16 can be executed each time the user inputs a message, the process may be executed in consideration of a processing load. For example, the process may be executed each time a certain number of input messages are received.

In step S101, the proposal unit 19 determines whether workflows are associated with the current executing agent. This step prevents a workflow that is not assumed by the executing agent from being executed so that an intended result is acquired.

When workflows are associated with the current executing agent (YES in step S101), in step S102, the proposal unit 19 acquires messages input by the user and information output by the agent during the current session of interactive communication. The current session is a session after the interactive screen is displayed.

In step S103, the proposal unit 19 transmits to the AI 150 the information acquired in step S102 and a list of workflows associated with the executing agent, and requests the AI 150 to select a workflow. The actual processing may be performed by the control unit 12 and the AI control unit 17 in response to a request from the proposal unit 19.

In step S104, the proposal unit 19 identifies workflows proposed by the AI 150 from among the workflows of step S101.

In step S105, the display control unit 18 causes the terminal apparatus 20 to display a list of workflows identified in step S104.

According to the determination method illustrated in FIG. 16, the information processing apparatus 10 can propose workflows suitable for the content of interaction in a session automatically, that is, without selecting document data. In the determination method illustrated in FIG. 16, a workflow may be proposed at the time when document data is selected.

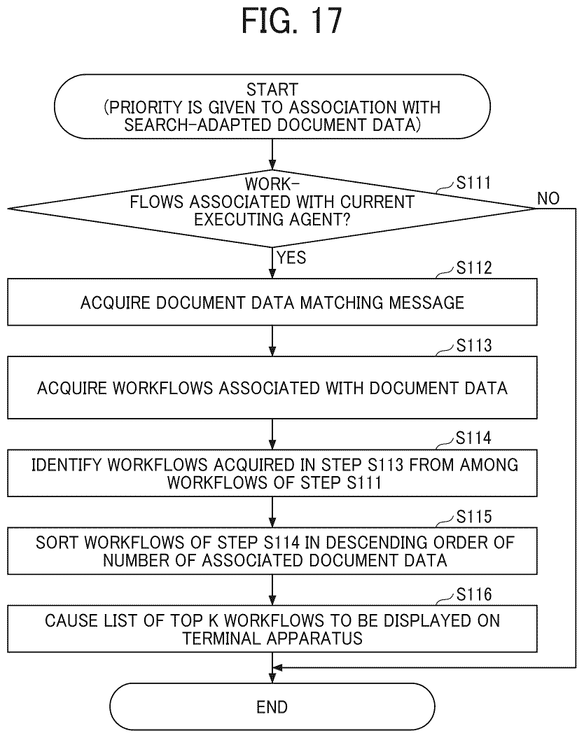

FIG. 17 is a flowchart of a determination method when (2) priority is given to association with search-adapted document data.

In step S111, the proposal unit 19 determines whether workflows are associated with the current executing agent. This step prevents a workflow that is not assumed by the executing agent from being executed so that an intended result is acquired.

When workflows are associated with the current executing agent (YES in step S111), in step S112, the proposal unit 19 acquires document data determined to be similar to the input message by the search unit 16.

In step S113, the proposal unit 19 acquires workflows associated with the document data from the workflow information storage unit 34. The proposal unit 19 also counts the number of associated document data for each workflow.

In step S114, the proposal unit 19 identifies the workflows acquired in step S113 from among the workflows of step S111.

In step S115, the proposal unit 19 sorts the workflows of step S114 in descending order of the number of associated document data.

In step S116, the display control unit 18 causes the terminal apparatus 20 to display a list of the top K workflows. In the process illustrated in FIG. 17, the workflows are associated with the document data. Thus, the proposal unit 19 maintains the correspondence between the workflows and the document data. The terminal apparatus 20 displays only workflows associated with the document data selected by the user.

According to the determination method illustrated in FIG. 17, the information processing apparatus 10 can propose workflows suitable for document data similar to an input message.

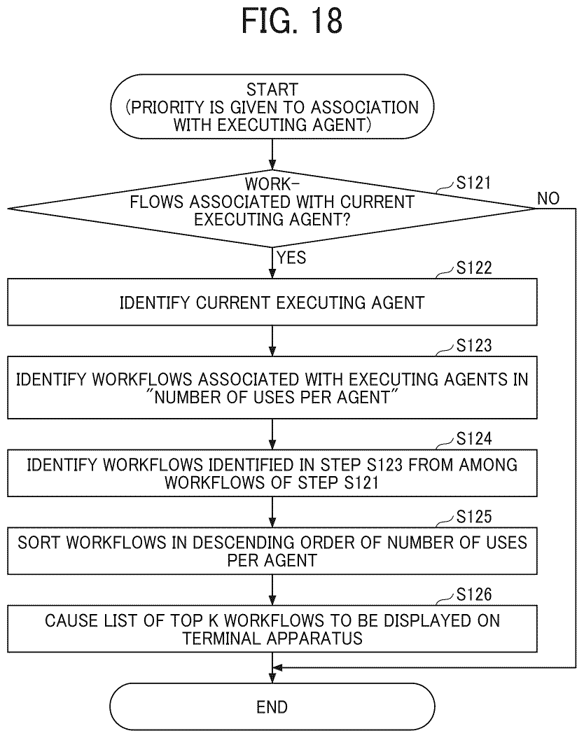

FIG. 18 is a flowchart of a determination method when (3) priority is given to association with an executing agent.

In step S121, the proposal unit 19 determines whether workflows are associated with the current executing agent. This step prevents a workflow that is not assumed by the executing agent from being executed so that an intended result is acquired.

When workflows are associated with the current executing agent (YES in step S121), in step S122, the proposal unit 19 identifies the current executing agent by, for example, making an inquiry to the control unit 12.

In step S123, the proposal unit 19 identifies workflows associated with the executing agent in the “number of uses per agent” item from the workflow information storage unit 34.

In step S124, the proposal unit 19 identifies the workflows identified in step S123 from among the workflows of step S121.

In step S125, the proposal unit 19 sorts the workflows in descending order of the number of uses per agent.

In step S126, the display control unit 18 causes the terminal apparatus 20 to display a list of the top K workflows.

According to the determination method illustrated in FIG. 18, the information processing apparatus 10 can propose workflows that are often executed by the current executing agent.

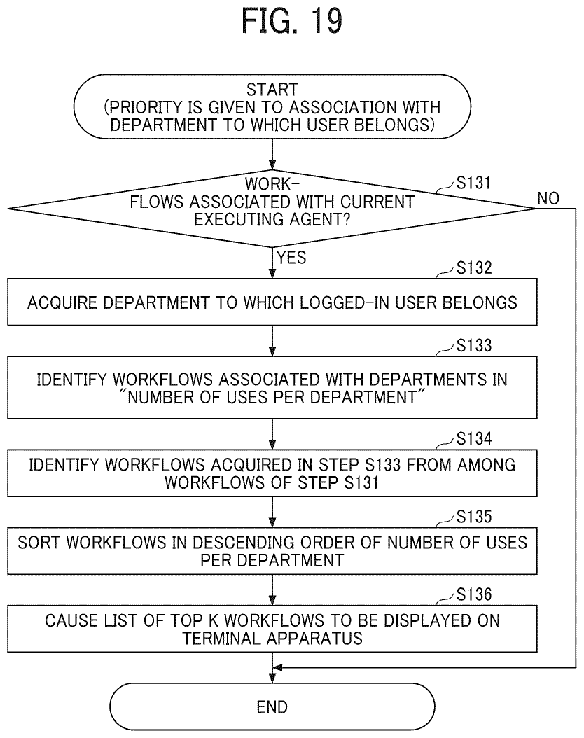

FIG. 19 is a flowchart of a determination method when (4) priority is given to association with a department to which a user belongs.

In step S131, the proposal unit 19 determines whether workflows are associated with the current executing agent. This step prevents a workflow that is not assumed by the executing agent from being executed so that an intended result is acquired.

When workflows are associated with the current executing agent (YES in step S131), in step S132, the proposal unit 19 acquires the department to which the logged-in user belongs by, for example, making an inquiry to the control unit 12.

In step S133, the proposal unit 19 identifies workflows associated with the department to which the logged-in user belongs in the “number of uses per department” item from the workflow information storage unit 34.

In step S134, the proposal unit 19 identifies the workflows identified in step S133 from among the workflows of step S131.

In step S135, the proposal unit 19 sorts the workflows in descending order of the number of uses per department.

In step S136, the display control unit 18 causes the terminal apparatus 20 to display a list of the top K workflows.

According to the determination method illustrated in FIG. 19, the information processing apparatus 10 can propose workflows that are often executed by a department to which a user belongs.

When the number of times of execution of workflows is associated with each user, the proposal unit 19 can propose workflows that are often executed by the user. In this case, the proposal unit 19 identifies, in step S133, workflows associated with the logged-in user in the “number of uses per user” item from the workflow information storage unit 34.

Screen Examples of Terminal Apparatus

Examples of screens displayed on the terminal apparatus 20 are described below with reference to, for example, FIG. 20. FIG. 20 is a diagram illustrating the interactive screen 510 displayed at the start of interaction. The interactive screen 510 includes an interaction display area 511, a message input area 512, and a button 513. The interaction display area 511 is an area in which the content of the interaction between the agent and the user is displayed. In the initial state, the interaction display area 511 displays a greeting sentence g1 “I am here to support your work.” to prompt the user to input a message. An icon ai1 representing the executing agent is displayed to the left of the greeting sentence g1. The icon ai1 is an image stored in a file relevant to the icon name of the agent information. The user can visually recognize the agent as the current dialogue partner, that is, the executing agent, by the icon ai1. The message input area 512 is an area for receiving an input message from the user, and includes the send icon 5121. The button 513 is a button for receiving an instruction to end the interaction.

FIG. 21 is a diagram illustrating the interactive screen 510 including output information. In the following description with reference to FIG. 21, identical or similar reference signs are given to elements similar to those described with reference to FIG. 20, and redundant descriptions thereof will be omitted unless otherwise required. In the interactive screen 510 illustrated in FIG. 21, an input message m1, a response message r1, and related document information d1 are added. The response message r1 and the related document information d1 are output information.

The input message m1 is an input message that the user has input in the message input area 512 in step S21 of FIG. 12. When the user clicks the send icon 5121, the input message that has been input in the message input area 512 is displayed in the interaction display area 511.

The response message r1 is a response message generated by the AI 150. The related document information d1 is document data matching the input message in the data storage unit 33 searched by the agent. In FIG. 21, a list of document names included in the related document information is displayed as the related document information d1. A check box 521 is displayed at the top of each document name for the user to select. The display format of the list of document names is an example, and the list of document names may be output by being divided into multiple speech bubbles.

In FIG. 21, an icon ui1 is added to the right of the input message m1, and an icon ai2 is added to the left of the response message r1. The icon ui1 is an icon of the user. The icon ai2 is an icon of the executing agent that has responded. Since the agent is not changed, the icon ai2, which is an example of a first icon, is the same as the icon ai1, which is an example of the first icon.

The user may continue the interaction or may end the interaction. To end the interaction, the user clicks the button 513. In this case, the session is terminated, and the procedures illustrated in FIGS. 13 and 14 are terminated. To continue the interaction, the user input a new message in the message input area 512 and clicks the send icon 5121. In this case, the input message is transmitted to the information processing apparatus 10, and steps after step S21 are repeated.

FIG. 22 is a diagram illustrating the interactive screen 510 displayed when document data is selected. In the following description with reference to FIG. 22, identical or similar reference signs are given to elements similar to those described with reference to FIG. 21, and redundant descriptions thereof will be omitted unless otherwise required. In the interactive screen 510 illustrated in FIG. 22, the check box 521 of one of the related documents is selected.

When the check box 521 is selected, a document list display menu 523 and an external function list display menu 524 are displayed. The document list display menu 523 and the external function list display menu 524 may be displayed together with the related document information d1. Both the document list display menu 523 and the external function list display menu 524 are pull-down menus. When the document list display menu 523 is pressed, the document data selected in the related document information d1 is displayed to allow the user to confirm the selected document data when the related document information d1 is scrolled out.

When the external function list display menu 524 is pressed, a list of workflows determined by the proposal unit 19 is displayed.

Although the selection of the document data triggers the display of workflows in FIG. 22, the document data is not essential for the execution of a workflow. A response message may be sufficient for the execution of a workflow. When the workflow is executed simply with a response message, workflows determined by one or more of the determination methods in the cases of (1) to (4) may be always displayed or may be displayed as a result of a user operation. The user selects a response message and a workflow to request execution of the workflow.

FIG. 23 is a diagram illustrating the interactive screen 510 including a workflow list. In the following description with reference to FIG. 23, identical or similar reference signs are given to elements similar to those described with reference to FIG. 22, and redundant descriptions thereof will be omitted unless otherwise required. In the interactive screen 510 illustrated in FIG. 23, a workflow list 525 is displayed in response to the external function list display menu 524 being pressed. In the workflow list 525, workflow names, such as “report generation” and “comparison table generation,” and execution buttons 526 corresponding to the respective workflow names are displayed. To execute a workflow, the user presses the execution button 526 corresponding to the workflow name. When document data is associated with workflows, that is, when workflows are determined by the determination method in the case of (2), the displayed workflows are changed in response to the user selecting another document data.

For example, the user presses the execution button 526 corresponding to the workflow name “report generation.” This transmits the execution request for the workflow “report generation” to the information processing apparatus 10. The external function cooperation unit 21 of the information processing apparatus 10 invokes the workflow server 5 via the API as described above with reference to the sequence diagram of FIG. 15, and requests the workflow server 5 to execute the workflow “report generation.” When the external function cooperation unit 21 acquires response information from the workflow server 5, the display control unit 18 causes the terminal apparatus 20 to display the response information.

Typically, the user has to download the related document information d1 to the terminal apparatus 20, connect the terminal apparatus 20 to the predetermined workflow server 5, and manually upload the related document information d1. By contrast, in the present embodiment, when the user selects document data on the interactive screen 510 and selects a workflow, the document data can be input into the workflow.

FIG. 24 is a diagram illustrating the interactive screen 510 including response information. In the following description with reference to FIG. 24, identical or similar reference signs are given to elements similar to those described with reference to FIG. 23, and redundant descriptions thereof will be omitted unless otherwise required. The interactive screen 510 illustrated in FIG. 24 displays an icon w1 representing the workflow server 5, together with response information s1. The icon w1 is an example of a second icon. The change from the icon ai to the icon w1 allows the user to determine that the current interaction is with the workflow server 5.

The response information s1 can be regarded as the execution result of the workflow definition process. The response information s1 is as follows.
{Which of the following report formats would you like to use?
1. Format A 2. Format B 3. Format C}
The user can select any desired option.

FIG. 25 is a diagram illustrating the interactive screen 510 including an input message resulting from the selection of an option. In the following description with reference to FIG. 25, identical or similar reference signs are given to elements similar to those described with reference to FIG. 24, and redundant descriptions thereof will be omitted unless otherwise required. The interactive screen 510 illustrated in FIG. 25 displays an input message m2 “Format A” as a result of the user selecting an option.

The option ID selected by the user is transmitted to the information processing apparatus 10. The external function cooperation unit 21 of the information processing apparatus 10 invokes the workflow server 5 via the API as described above with reference to the sequence diagram of FIG. 15, and transmits, for example, the option ID to the workflow server 5. When the external function cooperation unit 21 acquires the response information corresponding to the option ID from the workflow server 5, the display control unit 18 causes the terminal apparatus 20 to display the response information.

FIG. 26 is a diagram illustrating the interactive screen 510 including response information. In the following description with reference to FIG. 26, identical or similar reference signs are given to elements similar to those described with reference to FIG. 25, and redundant descriptions thereof will be omitted unless otherwise required. The interactive screen 510 illustrated in FIG. 26 displays the icon w1 representing the workflow server 5, together with response information s2. Since the response information s2 is generated by the workflow server 5, the icon w1 remains unchanged. The user can determine that the current interaction is with the workflow server 5.

The response information s2 can be regarded as the execution result of the workflow definition process. The response information s2 is as follows.
{The report is generated in Format A.
“Report.pdf”}

When the user presses this file name, the terminal apparatus 20 acquires and displays the report based on the embedded Uniform Resource Locator (URL). Although the report is displayed in a pop-up window in FIG. 26, the report may alternatively be displayed by transitioning to another window or screen.

In a case where the workflow definition is in “end” state at the time when the workflow server 5 outputs the report, the dialogue partner is changed to the agent. Accordingly, when the user inputs an input message, the icon ai displays a response message.

The information processing system 100 can generate information required for a user operation with high accuracy by inputting document data or a response message acquired by, for example, RAG into the external workflow server 5. Since the interaction with the agent and the interaction with the workflow server 5 are not disconnected, the interaction can be seamlessly continued from the agent to the workflow server 5. The information processing apparatus 10 can propose a workflow optimal for document data (or a response message), an executing agent, or a department to which a user belongs, for example.

### Second Embodiment

A second embodiment is described below. In the second embodiment, differences from the first embodiment will be described. Accordingly, aspects not specifically mentioned may be similar to those in the first embodiment.

In the second embodiment, the terminal apparatus 20 displays various screens by a web browser, and the information processing apparatus 10 has a function as a web server that executes a web application.

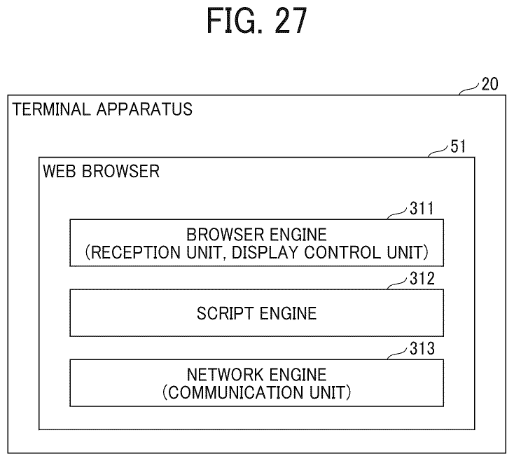

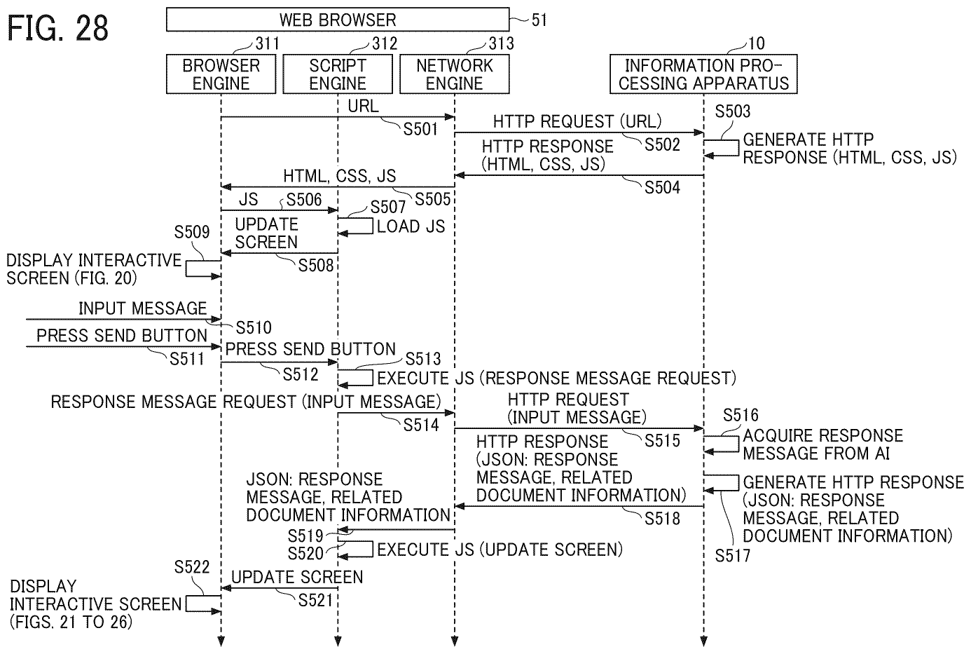

FIG. 27 is a diagram illustrating a functional configuration of the terminal apparatus 20 according to the second embodiment. In FIG. 27, the terminal apparatus 20 includes a web browser 51. The web browser 51 is a typical web browser, and includes a browser engine 311, a script engine 312, and a network engine 313.

The browser engine 311 interprets HyperText Markup Language (HTML) data and Cascading Style Sheets (CSS) data constituting a web page and renders the web page for display. The browser engine 311 corresponds to, for example, the reception unit 41 and the display control unit 43 of the first embodiment.

The network engine 313 transmits a HyperText Transfer Protocol (HTTP) request and receives an HTTP response. The network engine 313 corresponds to, for example, the communication unit 42 of the first embodiment.

The script engine 312 executes a script (for example, JavaScript®) constituting a web page. The script engine 312 determines how to process an input event based on the script and performs this processing. The processing includes display and communication. For example, the script engine 312 changes the content of the screen or updates the style, and causes the display control unit 43 to display the screen. The script engine 312 invokes a communication API, such as XMLHttpRequest or fetch, to cause the communication unit 42 to transmit data, receives a response from the server as an event, and causes the response to be displayed based on the script.

FIG. 28 is a sequence diagram illustrating a procedure for displaying a response message and other information according to the second embodiment. The sequence diagram of FIG. 28 illustrates a procedure corresponding to steps after step S16 illustrated in the sequence diagram of FIG. 12. However, steps S501 to S509 of FIG. 28 indicate a procedure for displaying the interactive screen 510 displayed at the start of interaction (FIG. 20), which is not clearly illustrated in FIG. 12.

The user's selection of an agent in step S16 of FIG. 12 corresponds to an instruction to display the interactive screen 510 (FIG. 20).

In step S501, in response to the instruction, the browser engine 311 inputs, into the network engine 313, a URL that is associated with the display instruction and serves as a destination for an HTTP request to the information processing apparatus 10.

In step S502, the network engine 313 transmits the HTTP request to the URL. The URL is notified by the information processing apparatus 10 as a URL corresponding to the selected agent ID, for example. Alternatively, the URL may be registered in a bookmark of the web browser 51, may be associated with a menu of a menu screen provided by the information processing apparatus 10, or may be directly input by the user.

In step S503, in response to the HTTP request, the display control unit 18 of the information processing apparatus 10 generates an HTTP response including web content data. The web content includes HTML data, CSS data, and a script, which may be referred to as “JS” in the following description.

In step S504, the display control unit 18 transmits the HTTP response to the terminal apparatus 20.

The web content data is an example of web content data that is used to display a first web page (for example, the interactive screen 510 illustrated in FIG. 20) and a second web page (for example, the interactive screen 510 illustrated in FIGS. 21 to 26) on which, for example, various messages and related document information are displayed, and that includes JS for causing the terminal apparatus 20 to execute at least a process for transmitting data input on the first web page to the information processing apparatus 10, and a process for displaying the second web page to display a response message and related document information, etc. In the present embodiment, the “response message and related document information, etc.” includes the workflow list 525 illustrated in FIG. 23, the options illustrated in FIG. 25, and the report illustrated in FIG. 26.

In step S505, in response to the HTTP response transmitted in step S504, the network engine 313 of the terminal apparatus 20 inputs the HTML data, the CSS data, and the JS included in the HTTP response into the browser engine 311.

In step S506, the browser engine 311 inputs the JS received from the network engine 313 into the script engine 312.

In step S507, the script engine 312 loads the JS.

In step S508, the script engine 312 requests the browser engine 311 to update the screen.

Updating the screen includes displaying a new screen.

The HTTP response generated in step S503 may include the file name of the JS instead of the actual JS. In this case, in step S507, the script engine 312 accesses the JS based on the file name and downloads the JS. This is a way of reading a JS as an external file.

The JS, which is included in the web content data that is used to display the first web page (for example, the interactive screen 510 illustrated in FIG. 20) to receive an input message, and the second web page (for example, the interactive screens 510 illustrated in FIGS. 21 to 26) to display the response message and related document information, etc., and which causes the terminal apparatus 20 to execute at least the process for transmitting the input message received on the first web page to the information processing apparatus 10 and the process for displaying the second web page to display the response message and related document information, etc., includes not only a JS directly described in the HTML but also a JS that is accessed based on the file name and downloaded by the way of reading a JS as an external file.

In step S509, the browser engine 311 displays the web page as the interactive screen 510 (FIG. 20) based on the HTML data and the CSS data.

The interactive screen 510 (FIG. 20) is a single web page in a single-page application, which is a web application having only one web page. After step S511, the content is updated for the single web page, and the interactive screens 510 illustrated in FIGS. 21 to 26 are displayed.

In step S510, the user inputs a message into the interactive screen 510 (FIG. 20).

In step S511, the user presses the send icon 5121.

In step S512, in response to the send icon 5121 being pressed, the browser engine 311 transmits to the script engine 312 a notification indicating that the send icon 5121 has been pressed.

In step S513, in response to the notification from the browser engine 311, the script engine 312 executes the JS.

In step S514, the script engine 312 inputs a request for a response message into the network engine 313 as a process in response to the send icon 5121 being pressed. The request includes the input message.

In step S515, the network engine 313 transmits an HTTP request as a request for a response message to the information processing apparatus 10. The HTTP request is an example of an HTTP request that is transmitted from the terminal apparatus 20 executing the JS, and that includes data input on the interactive screen 510 (FIG. 12) displayed on the terminal apparatus 20 based on the web content data.

In step S516, in response to the HTTP request, the AI control unit 17 of the information processing apparatus 10 generates a prompt as described above with reference to step S39 of FIG. 13, and acquires a response message from the AI 150.

In step S517, the display control unit 18 generates an HTTP response including JSON in which the response message and related document information, etc. are described to cause the terminal apparatus 20 to execute the JS to display the interactive screens 510 illustrated in, for example, FIGS. 21 to 26.

In step S518, the display control unit 18 transmits the HTTP response to the terminal apparatus 20.

In step S519, in response to the HTTP response, the network engine 313 of the terminal apparatus 20 inputs the response message and related document information, etc. included in the HTTP response into the script engine 312.

In step S520, the script engine 312 executes the JS.

In step S521, the script engine 312 requests the browser engine 311 to update the display content of the web page as a process in response to the response message and related document information, etc.

In step S522, the browser engine 311 displays the interactive screens 510 illustrated in, for example, FIGS. 21 to 26, as screens after the update, based on the HTML data and the CSS data acquired in step S505.

As described above, in the second embodiment, the interactive screen 510 (FIG. 20) and the interactive screens 510 (FIGS. 21 to 26) and the execution of the processing according to the operation on each of these screens are implemented by the single-page application. Specifically, the web content data that is distributed to the terminal apparatus 20 to display the interactive screen 510 (FIG. 20) is not the web content data that is used to display only the interactive screen 510 (FIG. 20), but the web content data that is used to display the interactive screen 510 (FIG. 20) and the interactive screens 510 (FIGS. 21 to 26) and includes the JS for executing the processes such as the screen transition according to the operations on the interactive screens 510 (FIG. 20 and FIGS. 21 to 26). Since the screen transition to the interactive screens 510 illustrated in FIGS. 21 to 26 is executed by the JS, the terminal apparatus 20 does not need to download the web content data for displaying each of the interactive screens 510 illustrated in FIGS. 21 to 26. Accordingly, the display speed of the interactive screens 510 illustrated in FIGS. 21 to 26 can be increased and the communication load can be reduced in the screen transition.

### Other Application Examples

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Although a workflow is exemplified as an external function in the present embodiment, the external function may alternatively be a service in which a server on a network processes data. For example, the external function may be translation, voice recognition, image recognition, natural language processing, or web page generation. The external function may be a function in which a certain period of time elapses between the input of a prompt to the output of a response message. Such an external function may be, for example, daily report generation, weekly report generation, or monthly report generation.

Configuration examples such as that illustrated in FIG. 3 are divided according to main functions to facilitate understanding of the processing performed by the terminal apparatus 20 and the information processing apparatus 10. The present disclosure is not limited by how the processing is divided or by the names of the processing units. The processing of each of the terminal apparatus 20 and the information processing apparatus 10 can be divided into more processing units according to the processing content. Also, a single processing unit can be divided to include more processing tasks.

The apparatuses or devices described in the above-described embodiments are merely one example of multiple computing environments for implementing the embodiments disclosed herein. In some embodiments, the information processing apparatus 10 includes multiple computing devices, such as a server cluster. The multiple computing devices are configured to communicate with each other through any type of communication links, including a network or a shared memory, to perform the processes disclosed herein.

Further, the information processing apparatus 10 may be configured to share the processing steps disclosed herein in various combinations. For example, a process executed by a predetermined unit may be executed by multiple information processing devices included in the information processing apparatus 10. The components of the information processing apparatus 10 may be integrated into one server apparatus or may be divided into multiple apparatuses.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a recording medium such as a compact disc read-only memory (CD-ROM) or DVD, and/or the memory of an FPGA or ASIC.

The present disclosure includes the following aspects.

According to a first aspect, an information processing system includes a reception unit, a search unit, an external function cooperation unit, and a display control unit. The reception unit receives an input message for an interactive AI interacting with a user. The search unit searches for document data using the input message. The external function cooperation unit transmits the document data searched by the search unit to an external system and acquires an execution result of an external function executed using the transmitted document data. The display control unit causes the execution result, acquired from the external system by the external function cooperation unit, to be displayed.

According to a second aspect, the information processing system of the first aspect further includes an AI control unit that transmits the input message and the searched document data to the AI and acquires a response message from the AI. The external function cooperation unit transmits the acquired response message to the external system in addition to the searched document data, and acquires another execution result of the external function executed using the transmitted response message in addition to the transmitted document data. The display control unit causes the execution result, acquired from the external system by the external function cooperation unit, to be displayed.

According to a third aspect, in the information processing system of the first aspect, the display control unit causes one or more document data searched by the search unit to be displayed. When the reception unit receives selection of document data from among the one or more displayed document data, the display control unit causes an external function list to be displayed, the reception unit receives selection of an external function from the external function list displayed by the display control unit, and the external function cooperation unit transmits the selected document data to the external system and requests the external system to execute the external function of which the selection is received by the reception unit.

According to a fourth aspect, in the information processing system of the third aspect, the display control unit causes, as the external function list, a list of one or more external functions associated with the interactive AI in advance to be displayed.

According to a fifth aspect, in the information processing system of the third or fourth aspect, the external function cooperation unit transmits to the external system the document data of which the selection is received by the reception unit, and acquires the execution result of the external function executed using the document data from the external system.

According to a sixth aspect, the information processing system of any one of the third to fifth aspects further includes an AI control unit that transmits to the AI the input message and document data adapted to a search performed by the search unit, and acquires a response message from the AI. The display control unit causes the response message, acquired from the AI, to be displayed, and causes the execution result, acquired from the external system by the external function cooperation unit, to be displayed on a screen on which the response message acquired from the AI is displayed.

According to a seventh aspect, in the information processing system of the sixth aspect, the display control unit causes the acquired response message to be displayed together with a first icon associated with the interactive AI, and causes the execution result acquired from the external system to be displayed together with a second icon associated with the external system. The first icon and the second icon are different from each other.

According to an eighth aspect, the information processing system of the third aspect further includes a proposal unit that determines an external function to be proposed to the user based on a preset determination method. The display control unit causes a list of one or more external functions determined by the proposal unit to be displayed.

According to a ninth aspect, in the information processing system of the eighth aspect, one or more external functions are associated with the interactive AI in advance. The proposal unit determines the external function to be proposed to the user, among the one or more external functions associated with the interactive AI, based on messages input by the user and information output by the interactive AI during a session of interactive communication.

According to a tenth aspect, in the information processing system of the eighth aspect, one or more external functions are associated with the interactive AI in advance. The proposal unit identifies one or more external functions associated with one or more document data adapted to a search by the search unit, based on information associating document data with an external function executed when the document data is selected, and determines, as the external function to be proposed, an external function associated with a current interactive AI among the one or more identified external functions.

According to an eleventh aspect, in the information processing system of the eighth aspect, the proposal unit prioritizes an external function associated with a current interactive AI and used a greater number of times, based on information associating an external function with an interactive AI interacting when the external function is executed and the number of times the external function is used during a session with the interactive AI, and determines the prioritized external function as the external function to be proposed.

According to a twelfth aspect, in the information processing system of the eighth aspect, one or more external functions are associated with the interactive AI in advance. The proposal unit prioritizes and identifies one or more external functions used a greater number of times by a department to which a user currently logged in belongs, based on information associating an external function with a department to which a user who has logged in when the external function is executed belongs and the number of times the external function is used by the department, and determines, as the external function to be proposed, an external function included in the one or more external functions associated with the interactive AI among the one or more prioritized and identified external functions.

According to a thirteenth aspect, in the information processing system of the eighth aspect, one or more external functions are associated with the interactive AI in advance. The proposal unit prioritizes and identifies one or more external functions used a greater number of times by a user currently logged in, based on information associating an external function with a user who has logged in when the external function is executed and the number of times the external function is used by the user, and determines, as the external function to be proposed, an external function included in the one or more external functions associated with the interactive AI among the one or more prioritized and identified external functions.

According to a fourteenth aspect, in the information processing system of any one of the first to thirteenth aspects, the external function is a workflow registered in advance for the interactive AI.

According to one or more aspects of the present disclosure, external functions can be utilized during interaction with interactive AI.

1. An information processing system, comprising circuitry configured to:
receive an input message for an interactive AI interacting with a user;
search for document data using the input message;
transmit the searched document data to an external system;
acquire an execution result of an external function executed using the transmitted document data from the external system; and
display the acquired execution result on a display.

2. The information processing system according to claim 1, wherein the circuitry is further configured to:
transmit the input message and the searched document data to the interactive AI;
acquire a response message from the interactive AI;
transmit the acquired response message to the external system in addition to the searched document data;
acquire, from the external system, another execution result of the external function executed using the transmitted response message in addition to the transmitted document data; and
display said another execution result on the display.

3. The information processing system according to claim 1, wherein
the circuitry is configured to display one or more searched document data, including the searched document data, on the display, and
in response to selection of document data from among the one or more displayed document data, the circuitry is configured to:
display an external function list on the display;
receive selection of an external function from the displayed external function list;
transmit the selected document data to the external system; and
request the external system to execute the external function of which the selection is received.

4. The information processing system according to claim 3, wherein
one or more external functions are associated with the interactive AI in advance, and
the circuitry is configured to display, as the external function list, a list of the one or more external functions associated with the interactive AI on the display.

5. The information processing system according to claim 3, wherein the circuitry is configured to transmit to the external system the document data of which the selection is received.

6. The information processing system according to claim 3, wherein the circuitry is further configured to:
transmit to the interactive AI the input message and search-adapted document data;
acquire a response message from the interactive AI;
display the acquired response message on the display; and
display the acquired execution result on a screen on which the acquired response message is displayed.

7. The information processing system according to claim 6, wherein the circuitry is configured to:
display the acquired response message on the display together with a first icon associated with the interactive AI; and
display the acquired execution result on the display together with a second icon different from the first icon and associated with the external system.

8. The information processing system according to claim 3, wherein the circuitry is further configured to:
determine an external function to be proposed to the user based on a preset determination method; and
display, as the external function list, a list of one or more determined external functions, including the determined external function, on the display.

9. The information processing system according to claim 8, wherein
one or more external functions are associated with the interactive AI in advance, and
the circuitry is configured to determine the external function to be proposed to the user among the one or more external functions associated with the interactive AI, based on the input message from the user and information output by the interactive AI during a session of interactive communication.

10. The information processing system according to claim 8, wherein
one or more external functions are associated with the interactive AI in advance, and
the circuitry is configured to:
identify one or more external functions associated with one or more search-adapted document data, based on information associating document data with an external function executed when the document data is selected; and
determine, as the external function to be proposed, an external function included in the one or more external functions associated with the interactive AI as a current interactive AI among the one or more identified external functions.

11. The information processing system according to claim 8, wherein the circuitry is configured to:
identify an external function associated with a current interactive AI and used a greater number of times, based on information associating an external function with an interactive AI interacting when the external function is executed and a number of times the external function is used during a session with the interactive AI; and
determine the identified external function as the external function to be proposed.

12. The information processing system according to claim 8, wherein one or more external functions are associated with the interactive AI in advance, and the circuitry is configured to:
identify one or more external functions used a greater number of times by a department to which the user currently logged in belongs, based on information associating an external function with a department to which a user who has logged in when the external function is executed belongs and a number of times the external function is used by the department; and
determine, as the external function to be proposed, an external function included in the one or more external functions associated with the interactive AI among the one or more identified external functions.

13. The information processing system according to claim 8, wherein one or more external functions are associated with the interactive AI in advance, and the circuitry is configured to:
identify one or more external functions used a greater number of times by the user currently logged in, based on information associating an external function with a user who has logged in when the external function is executed and a number of times the external function is used by the user; and
determine, as the external function to be proposed, an external function included in the one or more external functions associated with the interactive AI among the one or more identified external functions.

14. The information processing system according to claim 1, wherein the external function is a workflow registered in advance for the interactive AI.

15. An information processing apparatus, comprising circuitry configured to:
receive an input message for an interactive AI interacting with a user;
search for document data using the input message;
transmit the searched document data to an external system;
acquire an execution result of an external function executed using the transmitted document data from the external system; and
display the acquired execution result on a display.

16. An information processing method, comprising:
receiving an input message for an interactive AI interacting with a user;
searching for document data using the input message;
transmitting the searched document data to an external system;
acquiring an execution result of an external function executed using the transmitted document data from the external system; and
displaying the acquired execution result on a display.
